(19) United States
(12) Patent Application Publication
(10) Pub. No.: US 2009/0050258 A1
(43) Pub. Date: Feb. 26, 2009

(54) DEVELOPMENT OF PEM FUEL CELL ELECTRODES USING PULSE ELECTRODEPOSITION

(75) Inventors: Branko N. Popov, Columbia, SC (US); Yoon-Seok Choi, Athens, OH (US); Subasri M Ayyadurai, Columbia, SC (US); Jong-Won Lee, Columbia, SC (US)

Correspondence Address: DORITY & MANNING, P.A., POST OFFICE BOX 1449, GREENVILLE, SC, 29602-1449, US

(73) Assignee: University of South Carolina, Columbia, SC (US)

(21) Appl. No.: 12/196,630

(22) Filed: Aug. 22, 2008

Related U.S. Application Data
(60) Provisional application No. 60/965,714, filed on Aug. 22, 2007.

(51) Int. Cl. B32B 38/00; C25D 5/34; C25D 5/54

(52) U.S. Cl. 156/150; 205/210; 205/159

(57) ABSTRACT

In one embodiment of the present disclosure a method for forming a PEM fuel cell electrode is provided. The method includes applying a hydrophilic wetting agent on an electrode surface. A catalyst layer is deposited on the wetted electrode surface by pulse electrodeposition, at least a portion of the catalyst penetrating the electrode surface. The electrode surface is heat treated.

### CROSS-REFERENCE TO RELATED APPLICATION

The present application is based on and claims priority to U.S. Provisional Application 60/965,714 having a filing date of Aug. 22, 2007, which is incorporated by reference herein.

### FIELD OF INVENTION

The present invention relates to the field of PEM fuel cell technology.

### BACKGROUND OF INVENTION

A major impediment to the commercialization of fuel cell technology is the low activity and high content of unsupported platinum electrocatalysts used for oxygen reduction. Oxygen reduction process involves multiple electron transfer steps, and there is a significant activation energy barrier to its occurrence. Platinum is still considered the best electrocatalyst for the four-electron reduction of oxygen to water in acidic environments as it provides the lowest overpotentials and the highest stability. Increasing the oxygen reduction activity and/or platinum utilization of the gas diffusion electrode can lower the platinum loading in the electrode. Traditionally, platinum salts are reduced chemically by using a reducing agent. The ratio of Pt in carbon can be controlled by the initial concentration of Pt salts. However, when the Pt ratio is over 40 wt. %, the colloidal solution is not stable enough to keep the particle size under 4 nm. The oxygen reduction activity depends on the surface area available for reaction and hence on the particle size. Increase in particle size results in the decrease of activity and utilization of platinum. Thus, the Pt/C ratio cannot be increased beyond 40 wt. % by the traditional method without losing catalytic activity. Further, this limitation of Pt/C in carbon also imposes a limitation on decreasing the catalyst layer thickness. Since the ion exchange membrane used in proton exchange membrane (PEM) fuel cells is a solid type, the contact between membrane and Pt becomes a critical factor in order to obtain high performance. For this reason, the Pt should be placed more close to the surface of electrode.

In order to overcome this limitation, several non-powder type processes were developed. These processes create the catalyst directly on the surface of the carbon electrode or membrane. Another method is evaporative deposition, in which, Pt salt is evaporated and deposited on a membrane. A third Membrane Electrode Assembly (MEA) preparation technique is sputtering in which a very thin layer of sputter deposited platinum on a wet-proofed gas diffusion layer (GDL) performs very similarly to a standard E-TEK electrode. However, this technique is not a volume production method. It requires expensive vacuum equipment and cannot be used for fabrication of large structures with complex shapes.

A non-powder type electrodeposition technique has attracted attention due to its ease of preparation and low cost requirement. This process improves the utilization of a Pt catalyst. In this technique platinum ions are diffused through a thin Nafion layer and electrodeposited only in regions of ionic and electronic conductivity. This post-catalyzation process can avert the loss of active Pt sites by PTFE binder coverage. However, this process is strongly limited by diffusion of the Pt complex ion across the Nafion layer. To avoid this limitation, the method of impregnating carbon with H₂PtCl₆ and applying an electrochemical pulsed current to deposit Pt in the Nafion active layer was developed. This process guarantees a smaller active layer thickness and high platinum mass fraction up to 40 wt. %. However, in terms of Pt concentration distribution, it has a profile like that of a powder type process, and Cl⁻ ions produced from electrodeposition of Pt from H₂PtCl₆ remain in the active layer. The Cl- ions are known to poison platinum and reduce the catalytic activity of platinum.

The present invention seeks to address the disadvantages of prior art construction and methods and provides an improved method of developing PEM fuel cell electrodes.

### SUMMARY OF INVENTION

Objects and advantages of the disclosure will be set forth in part in the following description, or may be obvious from the description, or may be learned through the practice of the disclosure.

The present disclosure is a novel method of developing PEM fuel cell electrodes. The pulse deposition process requires a new hydrophilic layer to be deposited over the hydrophobic gas diffusion layer (GDL) by any one of various methods, including but not limited to tapping, spraying or screen-printing. Next, the pulse deposition is performed on the hydrophilic blank carbon electrode. After the deposition, the additive which introduces hydrophilic properties in the layer is removed using a temperature treatment. Since the formation and removal of the hydrophilic layer is very difficult to scale up for industry, the objective of the present invention is to substitute the loading of the hydrophilic layer over the hydrophobic GDL with a new activation process.

For instance, in one embodiment of the present disclosure a method for forming a PEM fuel cell electrode is provided. The method includes applying a hydrophilic wetting agent on an electrode surface, depositing a catalyst layer on the wetted electrode surface by pulse electrodeposition, at least a portion of the catalyst penetrating the electrode surface, and heat treating the electrode surface.

### DESCRIPTION OF FIGURES

A full and enabling disclosure, including the best mode thereof to one of ordinary skill in the art, is set forth more particularly in the remainder of the specification, including reference to the accompanying figures in which:

FIG. 1 illustrates a comparison of MEA performance between pulse deposited electrode and commercial electrodes.

FIG. 2 illustrates a backscattered electron image of the cross section of the MEA.

FIG. 3 illustrates a TEM image of Pt supported on carbon prepared by pulse electrodeposition.

FIG. 4 illustrates polarization curves of MEAs prepared by pulse electrodeposition with and without applying wetting agent.

FIG. 5 illustrates SEM images of Pt electrodeposited electrodes: (a) without applying wetting agent, (b) with applying wetting agent.

FIG. 6 illustrates results of water contact angle measurement for different GDL conditions.

FIG. 7 illustrates effect of the immersion time of wetting agent on the performance of the PEM fuel cell.

FIG. 8 illustrates backscattered electron images of the cross section of the MEA with different immersion time of the wetting agent: (a) 10 sec, (b) 30 sec, (c) 60 sec.

FIG. 9 illustrates effect of the total charge density on the performance of the PEM fuel cell.

FIG. 10 illustrates variation of the Pt loading with the total charge density.

FIG. 11 illustrates backscattered electron images of the cross section of the MEA with different total charge densities: (a) 2 C/cm², (b) 4 C/cm², (c) 6 C/cm², (d) 8 C/cm².

FIG. 12 illustrates variation of the thickness of the catalyst layer with the total charge density.

FIG. 13 illustrates effect of the Tₒₙ on the performance of the PEM fuel cell.

FIG. 14 illustrates variation of the Pt loading with the Tₒₙ.

FIG. 15 illustrates SEM images of Pt electrodeposited electrodes with different Tₒₙ: (a) 3 ms, (b) 6 ms, (c) 12 ms, (d) 24 ms.

FIG. 16 illustrates backscattered electron images of the cross section of the MEA with different Tₒₙ: (a) 3 ms, (b) 6 ms, (c) 12 ms, (d) 24 ms.

FIG. 17 illustrates Pt profiles of the cross section of the MEAs with different Tₒₙ.

FIG. 18 illustrates effect of the peak current density on the performance of the PEM fuel cell.

FIG. 19 illustrates effect of the T_{off} on the performance of the PEM fuel cell.

FIG. 20 illustrates variation of the Pt loading with the T_{off}.

FIG. 21 illustrates backscattered electron images of the cross section of the MEA with different T_{off}: (a) 100 ms, (b) 50 ms, (c) 25 ms, (d) 12.5 ms.

FIG. 22 illustrates Pt profiles of the cross section of the MEAs with different T_{off}.

FIG. 23 illustrates a TEM image of Pt supported on carbon prepared by pulse electrodeposition: (a) low magnification (×70000), (b) high magnification (×300000).

FIG. 24 illustrates polarization curves of MEAs prepared by pulse electrodeposition at 12 ms of Tₒₙ and 25 ms of T_{off}.

FIG. 25 illustrates a comparison of MEA performance between pulse electrodeposited electrode and E-TEK electrode.

FIG. 26 illustrates cyclic voltammagrams of the electrodes prepared at different peak current densities in pulse electrodeposition. Total charge density is fixed at 6 C/cm².

FIG. 27 illustrates effect of charge density on the performance of the PEM fuel cell.

FIG. 28 illustrates effective surface area and Pt loading with respect to the charge density.

FIG. 29 illustrates a schematic procedure for the preparation of platinum deposition on carbon substrate using electrochemical oxidation method.

FIG. 30 illustrates the effect of total charge density on the activity of pulse Pt deposited GDLs at the scan rate of 5 mV/sec (Peak current density=400 mA/cm², Tₒₙ=3 ms, T_{off}=100 ms).

FIG. 31 illustrates the effect of peak current density on the activity of pulse Pt deposited GDLs at the scan rate of 5 mV/sec (Total charge density=8 C/cm², Tₒₙ=3 ms, T_{off}=100 ms).

FIG. 32 illustrates the effect of peak current density on the effective surface area of pulse Pt deposited GDLs.

FIG. 33 illustrates the effect of thickness of hydrophilic layer on the activity of pulse Pt deposited GDLs at the scan rate of 5 mV/sec (Peak current density=400 mA/cm², total charge density=8 C/cm², Tₒₙ=3 ms, T_{off}=100 ms).

FIG. 34 illustrates anodic polarization curves of carbon substrate in different oxidation solutions: (a) 0.5M H₂SO₄, and (b) 0.1M KOH.

FIG. 35 illustrates variation of current density with surface oxidation time.

FIG. 36 illustrates the effect of oxidation time on the activity of carbon electrode for oxidation in H₂SO₄ solution.

FIG. 37 illustrates the effect of oxidation time on the activity of carbon electrode for oxidation in KOH solution.

FIG. 38 illustrates the effect of H₂SO₄ oxidation time on the activity of pulse Pt deposited GDLs at the scan rate of 5 mV/s (Peak current density=350 mA/cm², total charge density=10 C/cm², Tₒₙ=3 ms, T_{off}=100 ms).

FIG. 39 illustrates the effect of H₂SO₄ oxidation time on the effective surface area of pulse Pt deposited GDLs.

FIG. 40 illustrates the effect of KOH oxidation time on the activity of pulse Pt deposited GDLs at the scan rate of 5 mV/s (Peak current density=350 mA/cm², total charge density=10 C/cm², Tₒₙ=3 ms, T_{off}=100 ms).

FIG. 41 illustrates the effect of KOH oxidation time on the effective surface area of pulse Pt deposited GDLs.

FIG. 42 illustrates the effect of H₂SO₄ oxidation potential on the activity of pulse Pt deposited GDLs at the scan rate of 50 mV/s (Peak current density=400 mA/cm², total charge density=6 C/cm², Tₒₙ=3 ms, T_{off}=100 ms).

FIG. 43 illustrates the effect of KOH oxidation potential on the activity of pulse Pt deposited GDLs at the scan rate of 50 mV/s (Peak current density=400 mA/cm², total charge density=6 C/cm², Tₒₙ=3 ms, T_{off}=100 ms).

FIG. 44 illustrates the effect of total charge density on the activity of pulse Pt deposited GDLs with applying wetting agent at the scan rate of 5 mV/sec (Peak current density=400 mA/cm², Tₒₙ=3 ms, T_{off}=100 ms).

FIG. 45 illustrates the effect of wetting agent on the activity of pulse Pt deposited GDLs with tape casting at the scan rate of 5 mV/sec (Peak current density=400 mA/cm², total charge density=8 C/cm², Tₒₙ=3 ms, T_{off}=100 ms).

FIG. 46 illustrates the effect of wetting agent on the effective surface area of pulse Pt deposited GDLs with tape casting.

FIG. 47 illustrates backscattered electron images of the cross section of the membrane and electrode assembly (Cathode: pretreated by tade casting with wetting agent).

FIG. 48 illustrates the effect of wetting agent on the activity of pulse Pt deposited GDLs with oxidation at the scan rate of 5 mV/sec (Peak current density=400 mA/cm², total charge density=6 C/cm², Tₒₙ=3 ms, T_{off}=100 ms).

FIG. 49 illustrates the effect of wetting agent on the effective surface area of pulse Pt deposited GDLs with oxidation.

FIG. 50 illustrates backscattered electron images of the cross section of the membrane and electrode assembly (Cathode: pretreated by oxidation at 2.0 V in KOH with wetting agent).

FIG. 51 illustrates backscattered electron images of the cross section of the membrane and electrode assembly (Cathode: pretreated by applying wetting agent).

Table 1 is a summary of fuel cell performance and electrode properties with different total charge densities.

Table 2 is a summary of fuel cell performance and electrode properties with different Tₒₙ.

Table 3 is a summary of fuel cell performance and electrode properties with different T_{off}.

Table 4 shows optimized pulse parameters for pulse electrodeposition with applying wetting agent.

Table 5 shows comparison of fuel cell performance and electrode properties with commercial electrode.

Table 6 shows a comparison of ink composition.

Table 7 shows the effect of total charge density on the effective surface area of pulse Pt deposited GDLs.

Table 8 shows a summary of effective surface area and thickness of catalyst layer for different conditions.

### DETAILED DESCRIPTION OF INVENTION

It is to be understood by one of ordinary skill in the art that the present discussion is a description of exemplary embodiments only, and is not intended as limiting the broader aspects of the present disclosure, which broader aspects are embodied in the exemplary construction.

The present disclosure is aimed at optimizing PEM fuel cell performance by developing high Pt/C ratio catalysts with 3-4 nm particle size and an effective catalyst layer thickness of 1-2 microns. This was accomplished by selective coating of Pt on the gas diffusion layer (GDL) using pulse electrodeposition. Membrane Electrode Assembly (MEA) studies as further described herein show that the resulting electrode has improved characteristics over commercial E-TEK electrodes with less amount of catalyst.

In accordance with the present disclosure, the surface properties of the carbon support are optimized to get desired particle size while reducing the catalyst layer thickness. A hydrophilic layer is prepared on the electrode by using wetting agent as would be known in the art such as, but not limited to, isopropyl alcohol, ethanol or octanol. Platinum was deposited on the surface by pulse electrodeposition. This ensures that most of the platinum is in close contact with the membrane. Since the carbon support is essentially hydrophobic in nature, it has a very low affinity for solvents of polar character such as water and high affinity for nonpolar solvents such as wetting agent. Therefore, platinum (Pt) ions in aqueous electrolyte will be mostly located at the external surface of the carbon particle, but they can penetrate into the interior of the porous carbon layer when the carbon layer is treated with wetting agent, thus leading to a more uniform distribution throughout the particle.

The following Examples are intended to be purely exemplary of the present disclosure. In the Examples given below, experimental data are presented which show some of the results that have been obtained from embodiments of the present disclosure for different materials, temperatures, and processes.

### EXAMPLES

### Example 1

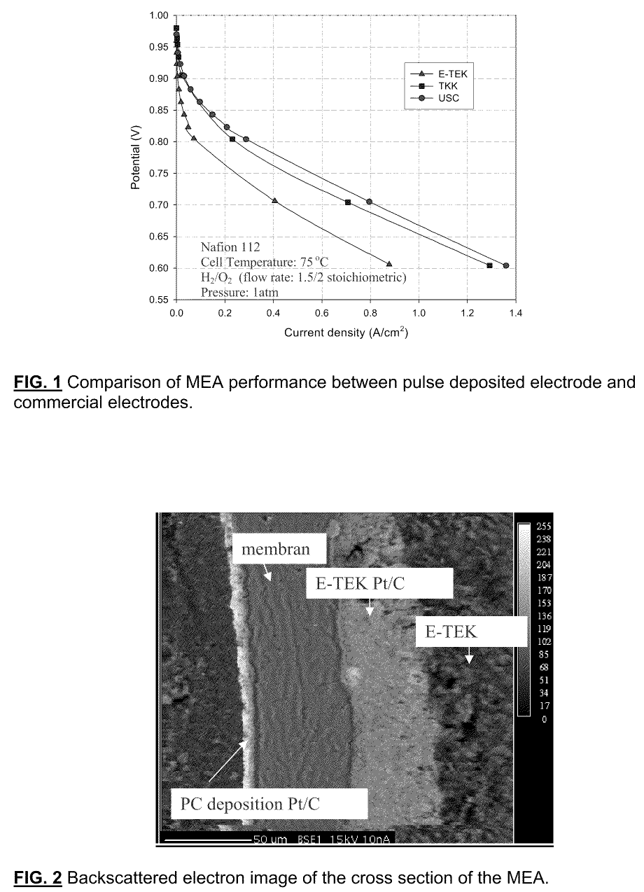

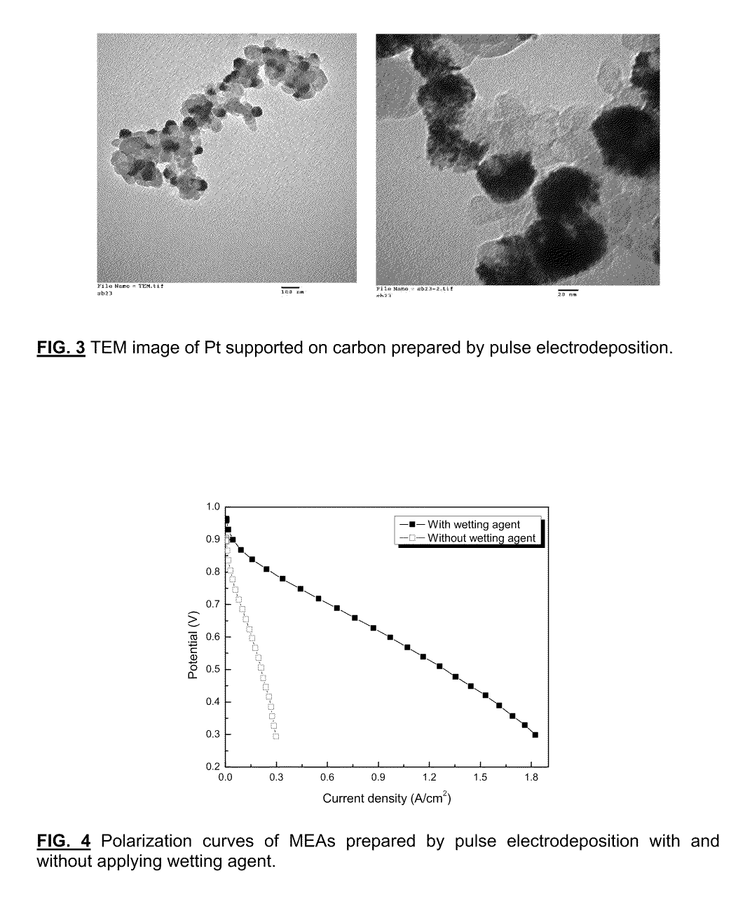

In experiments for the present disclosure, wetting agent was directly applied on the carbon substrate, and then platinum was deposited by pulse electrodeposition. The goal was to activate the hydrophobic gas diffusion electrode using surface modification with wetting agents, and to optimize the pulse parameters for low loading and high activity of Pt. The objective was to accomplish equivalent or better results compared to previous catalyst performance with loading less than 0.4 mg/cm². By using these deposition methods, it was found that 2˜3 nm particle size of platinum could be prepared. Studies of fuel cell performance obtained by this method showed 900 mA/cm² at the potential of 0.7 V and are summarized in FIGS. 1-3.

The following experiment is provided to illustrate the present invention and is not intended to limit the scope of the invention.

During electrodeposition, the thickness of the catalyst layer is controlled by the electrolyte penetration into the uncatalyzed carbon electrode. This phenomenon depends on the hydrophilic nature of the carbon electrode. In case of an excessive hydrophilic nature of the layer, the electrolyte penetrates deeply into the carbon support and the resulting catalyst is thicker than desired. A strong hydrophobic layer results in a deposition within a very narrow layer thereby leading to a formation of dendrites. Thus, the optimized hydrophilic property of the carbon support would lead to a desired particle size of Pt while reducing the Pt catalyst layer thickness.

The activation of the GDL prior to pulse deposition was carried out by applying wetting agent. The carbon substrate was immersed in the wetting agent for optimized wetting period. After wetting the surface, platinum was deposited by pulse electrodeposition.

Pulse electrodeposition of platinum was performed on the wetted carbon electrode using a Pt plating bath containing 10 g/L of H₂PtCl₆ and 60 g/L of HCl at room temperature. The electrodeposited size of the electrode was 5 cm². Platinum gauze was used as an anode. A pulse generator controlled both the pulse wave and the deposition current density. The current densities, the duty cycle and the total charge density were changed to optimize the deposition conditions in terms of metal particle size and coverage. The amount of platinum electrodeposited on the electrode was estimated by the weight difference before and after electrodeposition. After pulse deposition, the electrode was thoroughly rinsed with distilled water and dried for 24 h.

The platinum deposited electrodes were treated in H₂ at 300° C. for 2 h. After the heat treatment, the electro-catalyzed electrode was impregnated with 5 wt. % of Nafion solution by spraying and then dried at 80° C. for 2 h. The amount of Nafion loading was controlled to 0.8 mg/cm². The commercial E-TEK electrode (20 wt. % Pt/C, 0.4 mg/cm²) was used the anode for all tests. A total of 1.2 mg/cm² Nafion solution was applied to E-TEK anode electrodes by brushing and spraying. The Nafion-impregnated electrodes and the membrane (Nafion 112) were bonded to form a MEA by hot pressing at the temperature of 130° C. for 3 min at a pressure of 140 atm. The reaction gases were supplied through a humidifier and a mass flow controller from hydrogen and oxygen tanks. The reaction gases flowed according to the cell performance (1.5/2 stoics for H₂ and O₂). The cell was operated under ambient pressure.

The effect of wetting agent on the wettability of the GDL was measured using sessile-drop method. The measurements were performed using Rame-Hart contact angle standard goniometer provided with DROP image standard software. Water contact angle was measured by the shape of a water drop resting on a horizontally oriented surface. Energy dispersive analysis by X-ray (EDAX) coupled with environment scanning electron microscopy (ESEM) was used to obtain the surface morphology of the electrode and to measure the thickness of the electrocatalyst layer across the cross-sectioned MEA. The particle size of the Pt prepared by pulse electrodeposition was determined using transmission electron microscopy (TEM). The amount of Pt electrodeposited on the electrode was estimated by weight difference before and after deposition.

Effect of Wetting Agent on Electrode Performance

The pulse electrodeposition of Pt was performed on the as-received GDL and the GDL treated with wetting agent under the following conditions:

(i) Peak current density=400 mA/cm²,

(ii) On-time (Tₒₙ)=3 ms,

(iii) Off-time (T_{off})=100 ms, and

(iv) Total charge density=6 C/cm².

FIG. 4 compares the polarization curves for MEAs with and without applying wetting agent. As expected, the fuel cell performance was greatly improved when the wetting agent was used to activate the GDL. FIG. 5 shows the SEM images of the Pt-deposited electrodes prepared using the as-received GDL and the activated GDL. When no wetting agent is used, the platinum particles form large agglomerates (like Pt blacks) on the GDL surface. This is due to the fact that a strong hydrophobic nature of the as-received GDL would not allow the penetration of Pt-ions into the porous structure of carbon layer and consequently Pt deposition occurs only on the GDL surface. However, the activation of GDL with wetting agent results in the uniform dispersion of Pt particles with smaller sizes. It was also found that the Pt loading on the activated GDL (ca. 0.78 mg/cm²) is much higher that that on the as-received GDL (ca. 0.32 mg/cm²). It appears that the chemical reduction of [PtCl₆]²⁻ to Pt by the wetting agent produces more platinum nuclei in a same period while suppressing the growth of platinum particles.

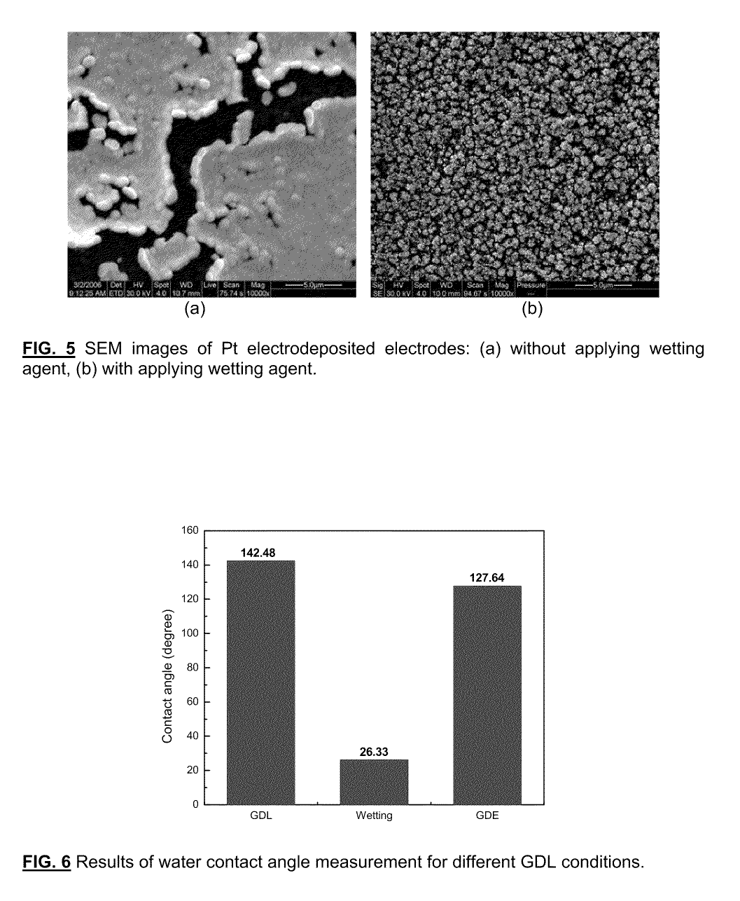

FIG. 6 shows the contact angles of water with (i) the as-received, (ii) the activated and (iii) the Pt-deposited GDL. The contact angle of water with the as-received GDL was measured to be 142.48° which indicates high hydrophobicity. However, after treatment with wetting agent for 10 s, the GDL surface is modified to be hydrophilic (θ=26.33°). This confirms that the wetting agent promotes the penetration of aqueous electrolyte into the porous structure of carbon layer. FIG. 6 also shows that after pulse deposition of Pt, the electrode surface again became hydrophobic, indicating complete removal of wetting agent. This further means that the Pt-deposited electrode would have good water management property during fuel cell operation.

The thickness of the Pt catalyst layer and electrode performance were optimized by optimizing the immersion time of GDL in wetting agent. The as-received GDL was treated with wetting agent for various times between 10 and 60 s. The pulse electrodeposition was performed on the activated GDL under the following conditions:

(i) peak current density=400 mA/cm², (ii) Tₒₙ=3 ms, (iii) T_{off}=100 ms and (iv) total charge density=8 C/cm².

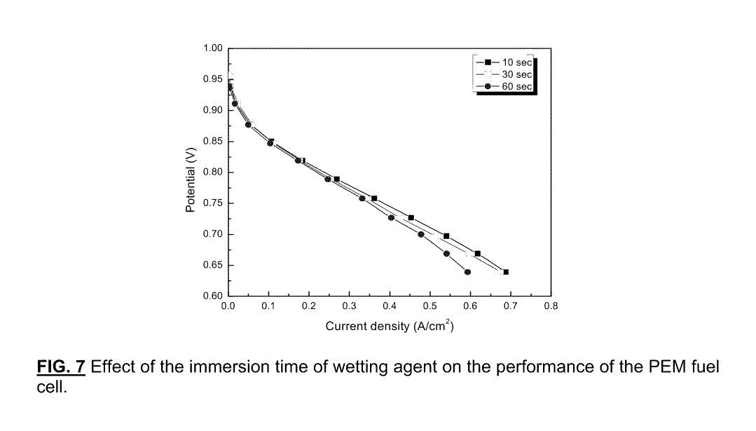

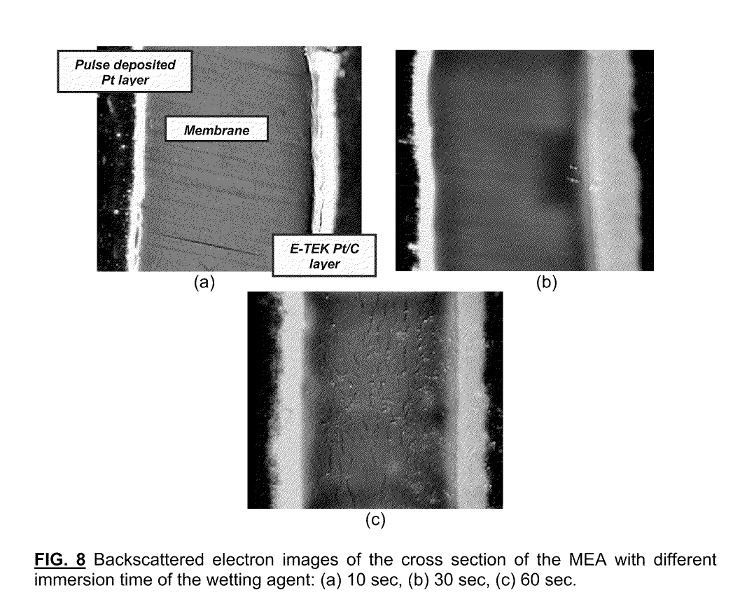

FIG. 7 shows the polarization curves for MEAs as a function of immersion time. The fuel cell performance decreased with increasing the immersion time in wetting agent. FIG. 8 represents backscattered electron images of the cross section of MEA consisting of an E-TEK anode and pulse deposited cathode. The bright portions between the membrane and the GDL indicate the Pt catalyst layer. The thickness of the Pt-deposited layer increased with increasing the immersion time. Generally, thicker active layer results in lower catalyst utilization due to transport limitations of dissolved oxygen and protons in the ionomer. Based on the fuel cell performance and thickness measurements, the activation time of GDL with wetting agent was optimized to be 10 s.

Optimization of Pulse Parameters

With the optimized activation time (10 s) of GDL with wetting agent, the effect of pulse parameters on the electrode performance was systematically studied with varying (i) total charge density, (ii) Tₒₙ, (iii) T_{off} and (iv) peak current density.

Effect of Total Charge Density

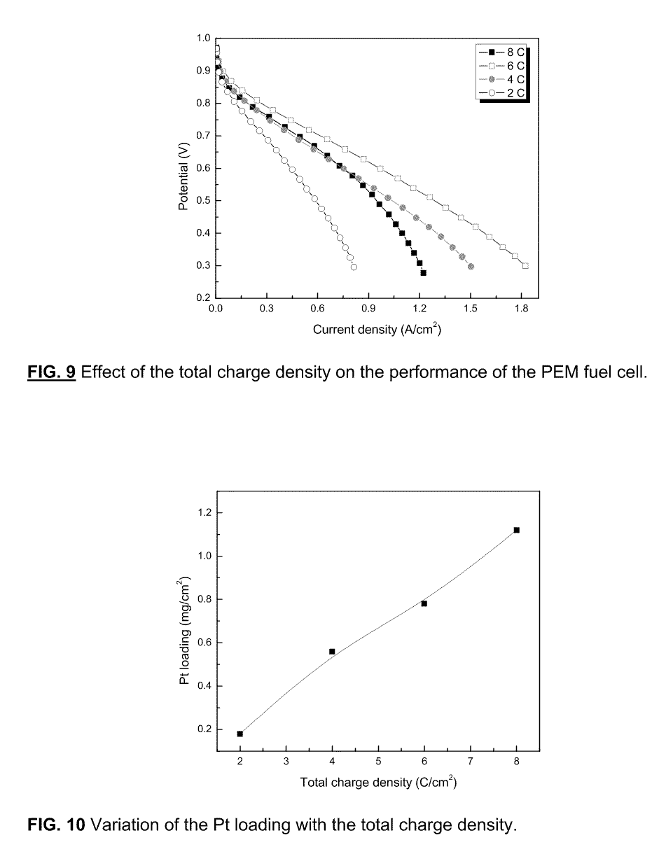

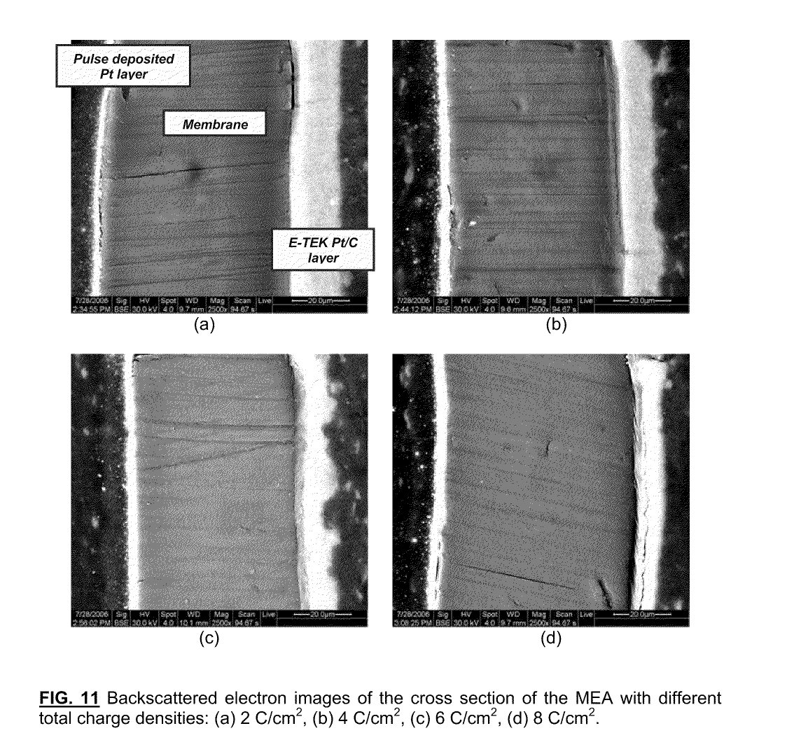

FIG. 9 shows the polarization curves of the MEAs as a function of total charge densities used for pulse deposition. The electrodeposition was performed under the following conditions: (i) peak current density 400 mA/cm², (ii) Tₒₙ=3 ms and (iii) T_{off}=100 ms. As shown in FIG. 9, the MEA performance increases with the increase in the total charge density from 2 to 6 C/cm². For charge higher than 6 C/cm², the MEA performance decreases. FIG. 10 represents the variation of Pt loading as a function of total charge density. The platinum loading increases from 0.18 to 1.12 mg/cm² with the increase in the total charge density. With increasing the platinum loading, the thickness of the catalyst layer increased as shown in FIGS. 11 and 12. Table 1 summarizes the fuel cell performance and electrode properties for different total charge densities. Based on these results, the total charge density was optimized to be 6 C/cm²; however, the Pt loading (0.8 mg/cm²) is still higher than that in commercial electrode (0.4 mg/cm²). The Pt loading was further optimized by optimizing Tₒₙ and T_{off}.

To obtain low loading and small particle size of platinum, gas-evolving electrochemical process is necessary in parallel with platinum electrodeposition. During a pulse, due to particle growth, the superficial concentration of adsorbed [PtCl₄]²⁻ species decreases. At the same time, the platinum surface area on which hydrogen evolution takes place increases, and this competitive reaction becomes overwhelmingly preponderant and acts as limiting factor on the particle size and the loading of platinum. At high overvoltage, since the rate of hydrogen evolution increases, the secondary nucleation can be inhibited by hydrogen atoms. Thus, to increase hydrogen evolution reaction rate, we tried to increase the average current density by varying Tₒₙ or T_{off}.

Effect of Pulse on Time (Tₒₙ)

Tₒₙ was varied in the range of 3 and 24 ms and the electrodeposition was performed under the following conditions: (i) total charge density=6 C/cm², (ii) peak current density=400 mA/cm², (iii) T_{off}=100 ms.

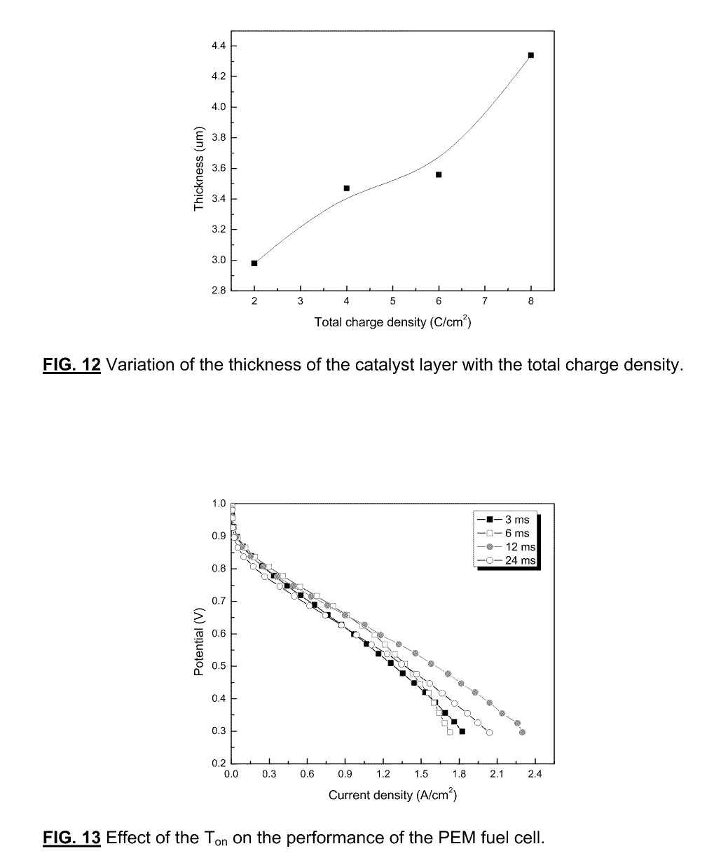

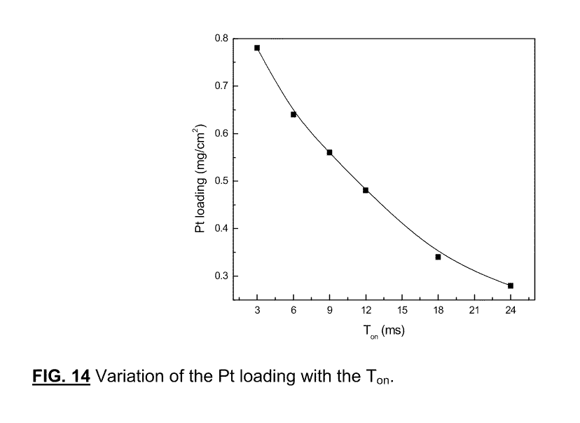

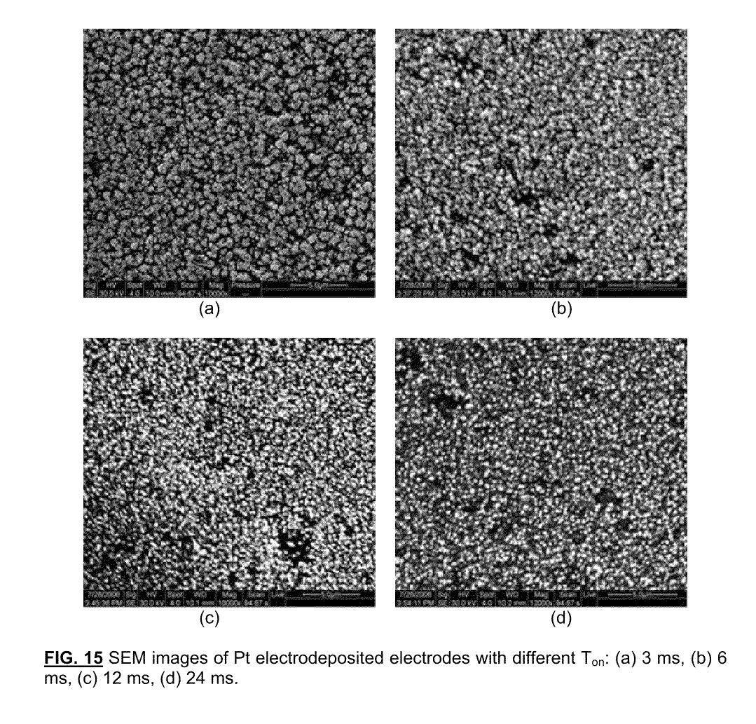

FIG. 13 shows the polarization curves of the MEAs as a function of Tₒₙ. The MEA performance increases with the increase of Tₒₙ from 3 to 12 ms. For Tₒₙ higher than 12 ms, the MEA performance decreases due to very low Pt loading (FIG. 14). FIG. 15 presents SEM surface images of electrodes prepared with different Tₒₙ. The grain size and agglomeration of Pt decreased with increasing Tₒₙ, indicating hydrogen evolution, which becomes the main electrochemical phenomenon on particles of sufficient size, is not detrimental and allows numerous and small particles to be obtained.

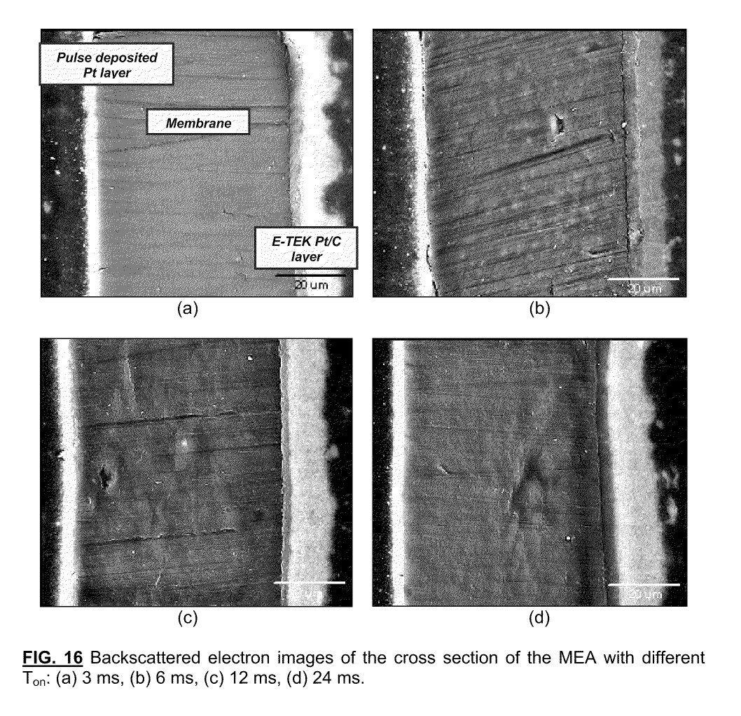

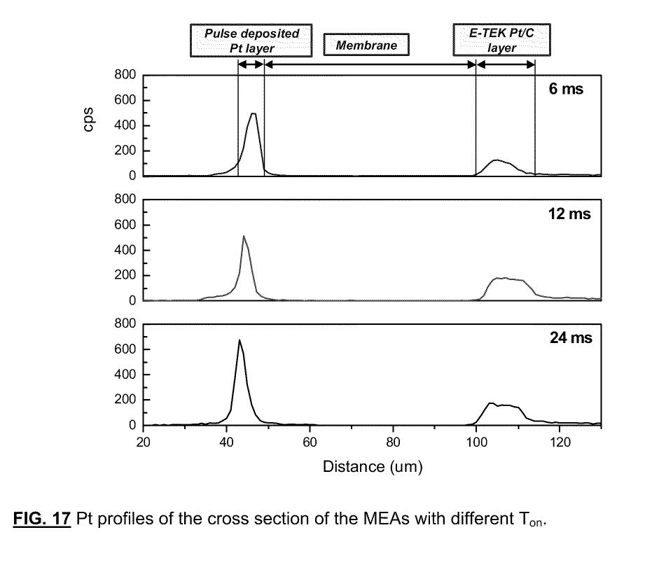

FIG. 16 represents backscattered electron images of the cross section of MEA consisting of an E-TEK anode and pulse deposited cathode. The result shows that the thickness of the pulse deposited catalyst layers is smaller compared to that of the E-TEK anode. The thickness of pulse deposited layers is in the range of 2.28 and 3.56 μm, whereas the E-TEK anode shows more than 10 μm thickness. The Pt concentration profiles measured across a typical portion of the cross section of MEAs by EPMA are shown in FIG. 17. The pulse deposited cathodes exhibit much higher intensity of Pt peak in the limited area near the membrane while the platinum line scan across the E-TEK anode shows a relatively uniform intensity.

Table 2 summarizes the fuel cell performance and electrode properties for different Tₒₙ. As shown in Table 2, the electrode prepared with Tₒₙ=6 ms showed higher current density at 0.7 V, both area-specific and volume-specific, than other electrodes. However, if the fuel cell performance is normalized with respect to the Pt loading, then the pulse deposition with Tₒₙ=12 ms leads to the best fuel cell performance over the whole potential ranges.

Effect of Peak Current Density

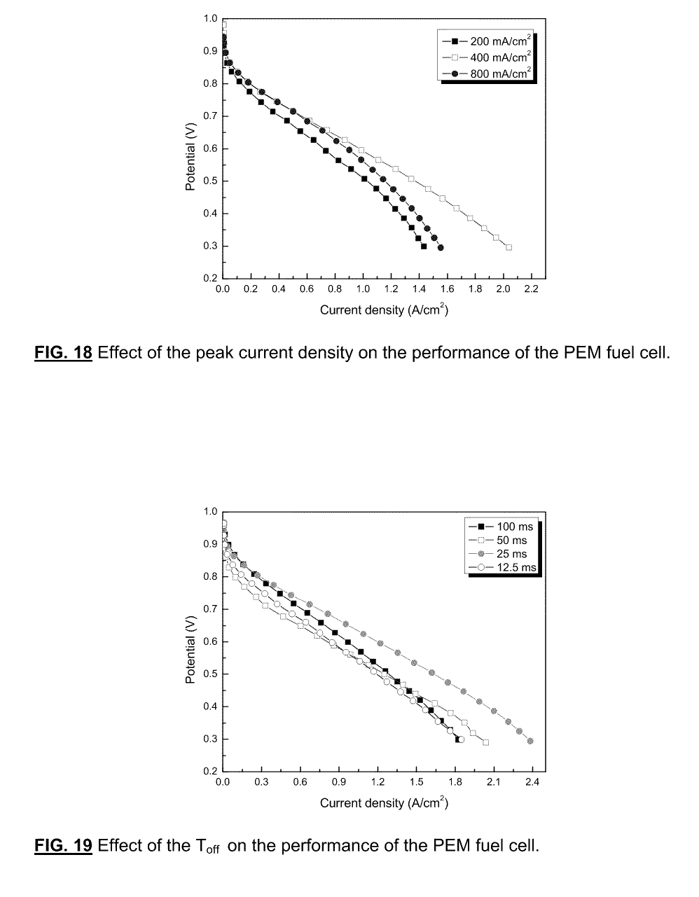

The peak current density was varied while keeping both the average current density (77.42 mA/cm²) and the total charge density (6 C/cm²) constant. FIG. 18 shows the polarization curves of the MEAs prepared using different peak current densities. The electrode prepared at peak current density of 400 mA/cm² shows better performance than those deposited at 200 and 800 mA/cm². Based on the results of fuel cell performance, the peak current density was optimized to be 400 mA/cm².

Effect of Pulse Off Time (T_{off})

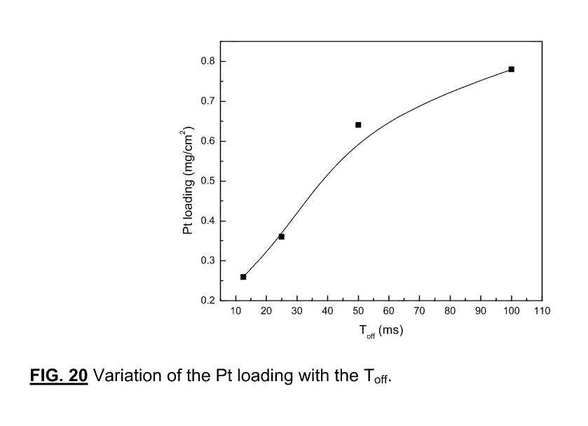

FIG. 19 shows the polarization curves of the MEAs as a function of T_{off}. The pulse electrodeposition was performed under the following conditions: (i) total charge density=6 C/cm², (ii) Tₒₙ=3 ms and (ii) peak current density=400 mA/cm². The electrode prepared at Tₒₙ=25 ms showed the best performance. Furthermore, the Pt loading of this electrode was measured to be 0.36 mg/cm² (FIG. 20) which is lower than that in commercial electrode.

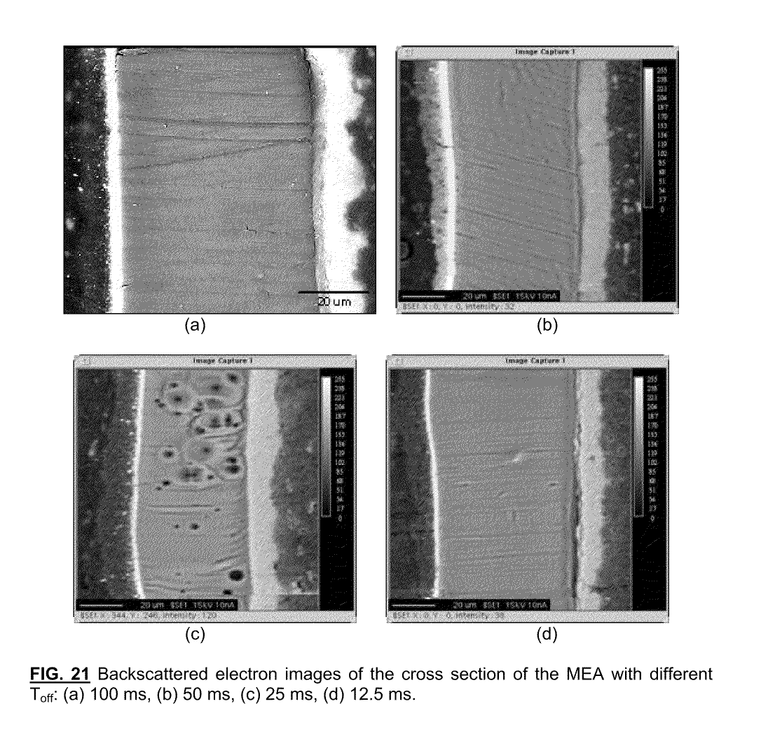

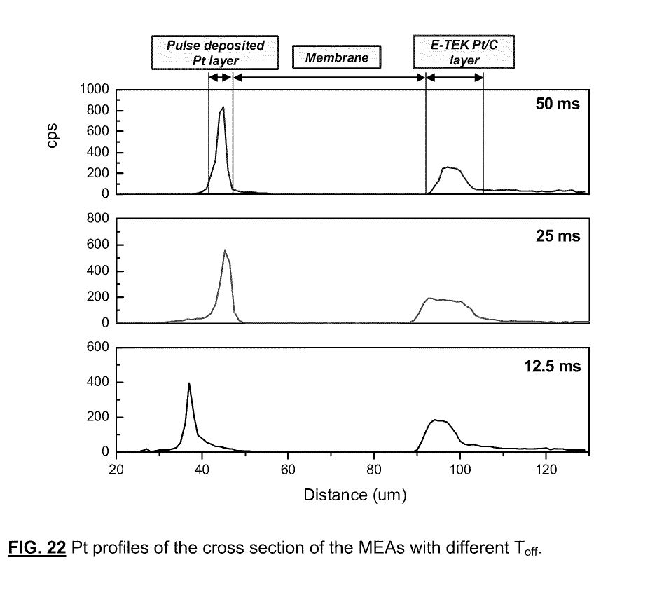

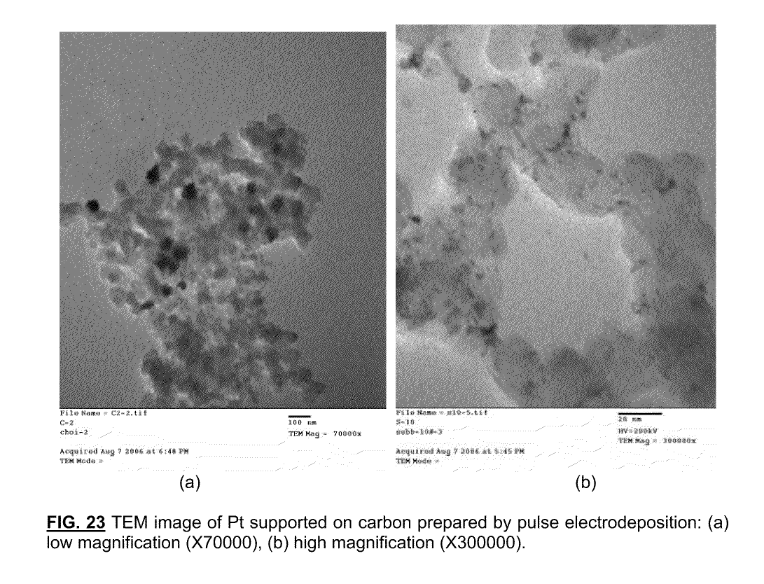

FIG. 21 represents backscattered electron images of the cross section of MEA consisting of an E-TEK anode and pulse deposited cathode with different T_{off}. From FIG. 21, the thickness of the catalyst layer, deposited with Tₒₙ=25 ms, was determined to be 2 μm. Furthermore, this very thin catalyst layer exhibits much higher intensity of Pt peak than the E-TEK anode electrode as shown in FIG. 22. FIG. 23 shows a typical TEM image of catalyst prepared by pulse electrodeposition with Tₒₙ=25 ms. In the low magnification TEM image (FIG. 23(a)), the dark spots indicate Pt particles. In addition, the particle size of carbon is 40˜60 nm and the particle size of platinum seems to be a somewhat similar. However, at high magnification (FIG. 23(b)), it is seen that the large particles consist of small particles with size of 3˜4 nm. This indicates that nano-sized Pt particles can be obtained using the optimized pulse electrodeposition condition with wetting agent.

Table 3 summarizes the fuel cell performance and electrode properties for different T_{off}. The electrode prepared with T_{off}=25 ms showed higher current density at 0.7 V, both area-specific and volume-specific, than other electrodes.

Optimized Pulse Parameters and Comparison with Commercial Electrode

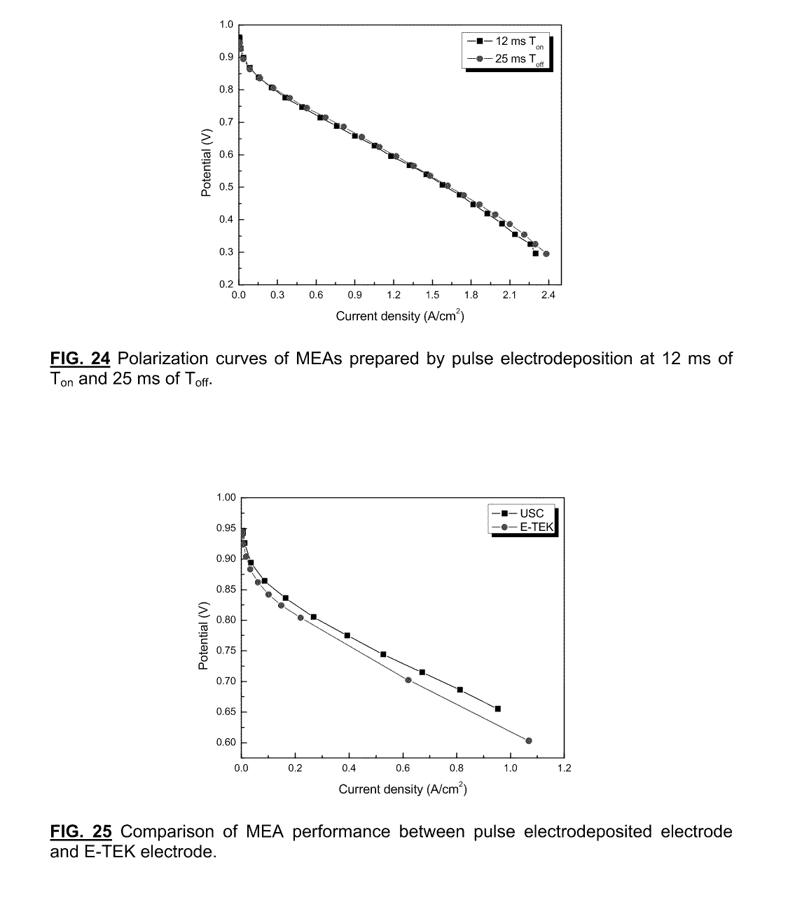

Table 4 represents the pulse parameters which showed best performance in each Tₒₙ and T_{off}. As shown in FIG. 24 and Table 4, the electrode deposited at 25 ms of T_{off} showed better performance with smaller loading than the electrode deposited at 12 ms of Tₒₙ. This indicates that the duration of the pulse off time plays an important role in the deposition to obtain smaller platinum size and loading.

FIG. 25 and Table 5 show the comparison of performance between the pulse electrodeposited electrode and the commercial E-TEK electrode. The results indicate that the pulse electrodeposited electrode has higher current densities and volumetric current densities at a given potential under same operating conditions with less amount of platinum loading (0.36 mg/cm²) and thickness (2 μm). The enhanced performance results from the improved electrode structure prepared by the pulse electrodeposition.

### Example 2

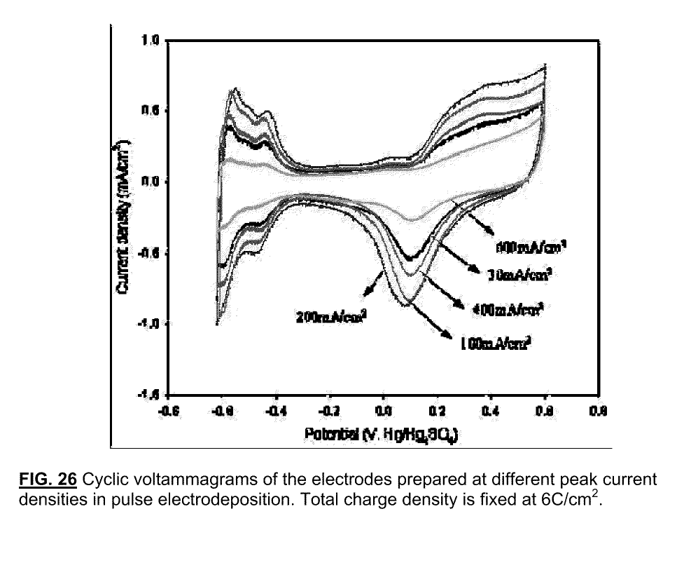

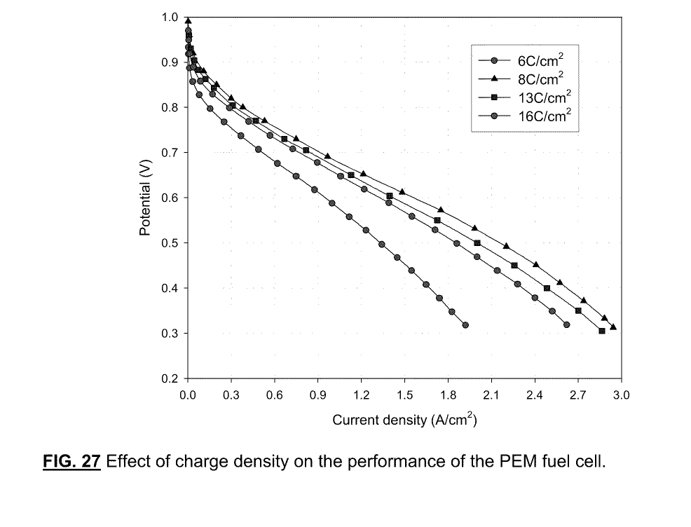

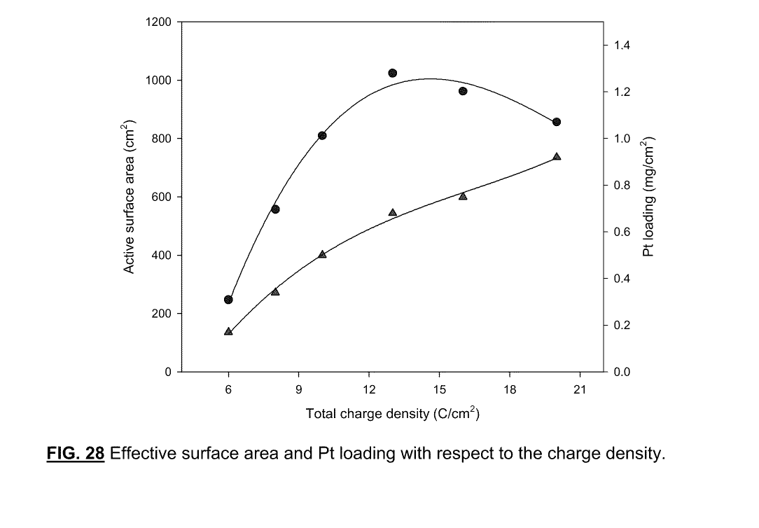

In the present example, the surface properties of the carbon support have been modified to get desired particle size while reducing the catalyst layer thickness. By using our deposition methods, it was found that 2˜3 nm particle size of platinum could be prepared. The effective surface area obtained by this method is 560 cm² at the charge density of 8 C/cm². The results are summarized in FIGS. 26-28.

The activation of the GDL prior pulse deposition was carried out by: (i) applying hydrophilic layer by tape casting, (ii) surface oxidation with sulfuric acid or potassium hydroxide, and (iii) by applying wetting agent.

A new hydrophilic layer is formed over the hydrophobic surface by applying a carbon ink composed of Vulcan carbon, isopropyl alcohol (IPA), organic solvent and binder (PTFE). Using the carbon ink, hydrophilic layer was formed by using tape casting. Table 6 summarizes the compositions of the carbon ink for our previous method and for tape casting. This method is very simple and can be easily adapted to industry.

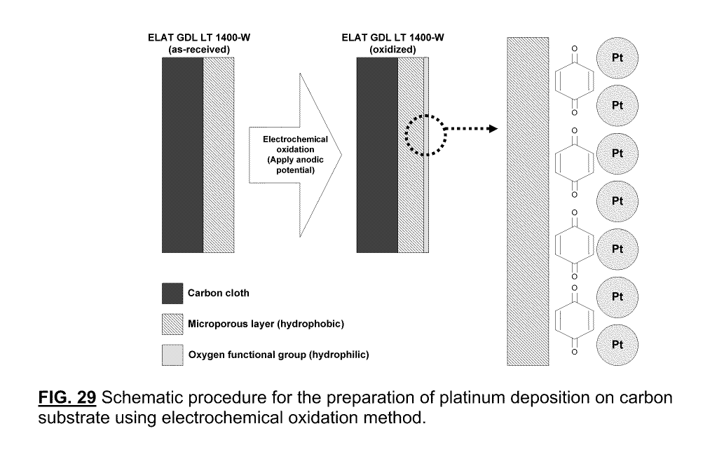

The carbon substrate was also electrochemically oxidized to increase the hydrophilic nature of the carbon electrode. Electrochemical oxidation of carbon electrode results in an increase of its activity measured by double layer charge, increase in roughness and the fractions of different functional groups on carbon surface. The degree of these changes depends on the conditions used for the electrochemical treatment of the material. Furthermore, the wet ability of carbon surfaces depends on the extent of surface oxidation. In other words, the carbon electrode surface changes from hydrophobic to hydrophilic by the surface oxidation processing. FIG. 29 summarizes the concept of electrochemical activation of carbon as a first step preceding the platinum deposition. Commercial gas diffusion layer (GDL LT 1400-W, E-TEK) was chosen as uncatalyzed carbon electrode which was composed of carbon cloth and hydrophobic micro porous carbon layer. When this GDL surface is oxidized under anodic conditions, surface oxygen functional groups such as quinine-hydroquinone are introduced on the carbon electrode. These surface oxygen functional groups on the carbon electrode surface provide a hydrophilic nature which can effectively deposit the nano-sized platinum. Electrochemical oxidation of carbon electrodes was performed in 0.5 M H₂SO₄ and on 0.1 M KOH at 25° C. Next, the samples were washed with distilled water and dried for 24 hours.

An attempt was made to prepare hydrophilic layer by coating the surface using wetting agent. Wetting agent was directly applied on the carbon substrate in an attempt to activate only the surface. After wetting the surface, platinum was deposited by pulse electrodeposition.

Pulse electrodeposition of platinum was performed on the oxidized carbon electrode using a Pt plating bath containing 1 g/L of H₂PtCl₆ and 60 g/L of HCl at room temperature. The oxidized carbon electrode was loaded on the sample holder. The electrodeposited size of the electrode was 5 cm². Platinum gauze was used as an anode. A pulse generator controlled both the pulse wave and the deposition current density. The current densities, the duty cycle and the charge density were changed to optimize the deposition rate. After pulse deposition, the electrode was thoroughly rinsed with distilled water and transferred to the cell containing 0.5 M H₂SO₄ with nitrogen purging. The effective surface area of platinum deposited was estimated by cyclic voltammagrams (CVs). To estimate the effective surface area of platinum, the CVs were recorded in 0.5 M H₂SO₄ by scanning the potential from 0.6 V to −0.65 V using a scan rates of 50 mV/s and 5 mV/s. The effective surface area of Pt was calculated from the area of hydrogen desorption peak between −0.62 and −0.25 V versus Hg/Hg₂SO₄ after subtracting the contribution of the double layer charge. This area is converted into the effective active surface area of Pt using the factor of 210 μC/cm². The effective surface areas were compared only with our previous results at the same total charge density.

All electrochemical measurements were conducted at room temperature in a standard electrochemical cell. The counter electrode was a Pt wire while a standard Hg/Hg₂SO₄ electrode was used as a reference one. All the potentials are expressed on the Hg/Hg₂SO₄ scale.

Preparation of Gas Diffusion Electrode by Applying Hydrophilic Layer

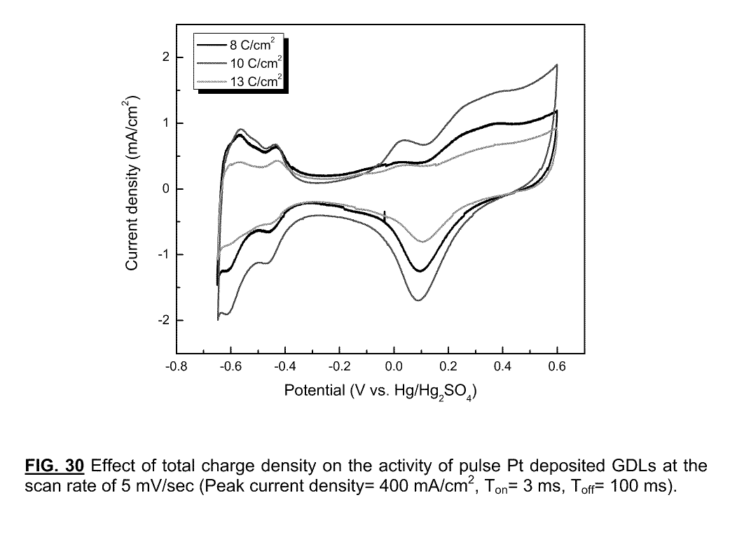

The effect of pulse parameters on Pt electrodeposition was studied to optimize the pulse parameters for the tape casting carbon substrate. In pulse electrodeposition, by varying the total charge applied for electrodeposition, the amount of Pt loading can be controlled. In order to study the effect of this parameter, the total charge density was varied in the range between 8 and 13 C/cm² while the peak current density and the duty cycle were fixed at 400 mA/cm² and 2.9 (3 ms on time, 100 ms off time), respectively. The duration of electrodeposition time was between 11.5 and 18.6 min. FIG. 30 shows the CVs of the samples prepared using different charge densities. Based on the area of hydrogen desorption peak, the effective surface area of Pt was calculated, and shown in Table 7. As shown in Table 7, the effective surface area decreases with the increase in the total charge density from 8 to 13 C/cm². The results can be explained by taking into account the fact that the carbon support area is insufficient to accommodate any new nucleation at higher total charge densities, which results in deposition of large particle sizes of the catalyst.

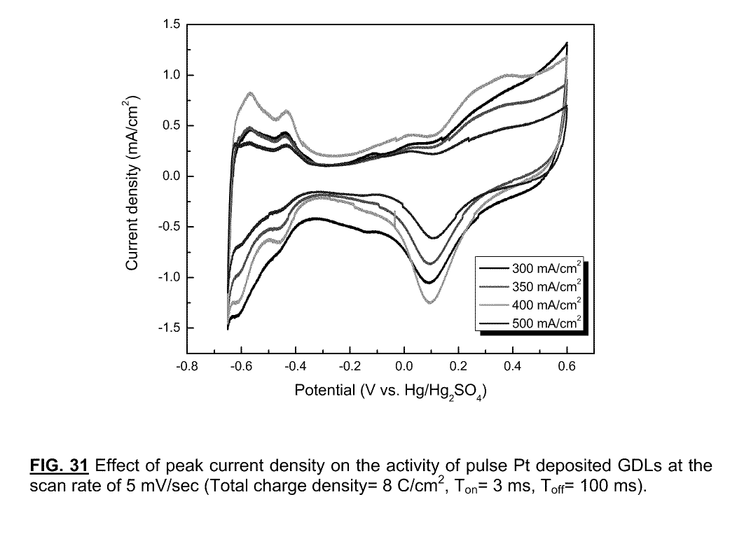

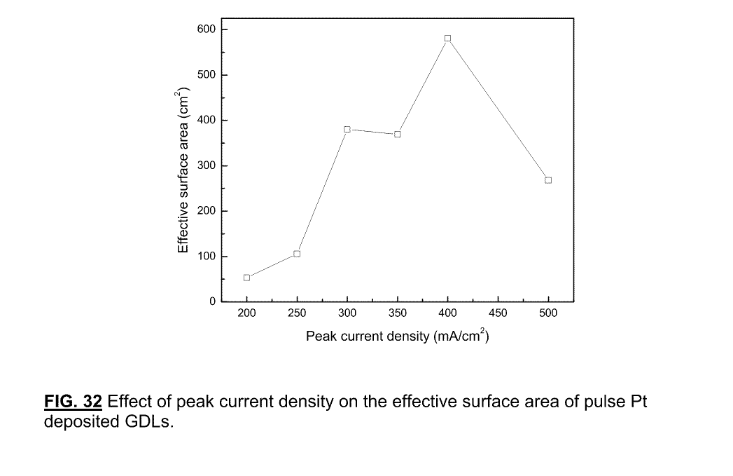

With the optimized total charge density (8 C/cm²), the effect of peak current density (PCD) was studied in the range between 300 mA/cm² and 500 mA/cm². FIG. 31 shows the CVs of electrodeposited electrodes prepared at different peak current densities. The effective surface areas as a function of the peak current densities are shown in FIG. 32. It is clear from this data that the peak current density does affect the active surface area of the Pt due to changes in Pt grain size. With increase in the peak current density up to 400 mAcm², the effective surface area of Pt increases, indicating that smaller particles of Pt are deposited. As shown in FIG. 32, the highest effective surface area is 580 cm² (measured for 5 cm² geometric area of the GDL) was obtained for peak current density of 400 mA/cm². The tape casting method to deposit the hydrophilic layer can be easily up scaled for industrial application.

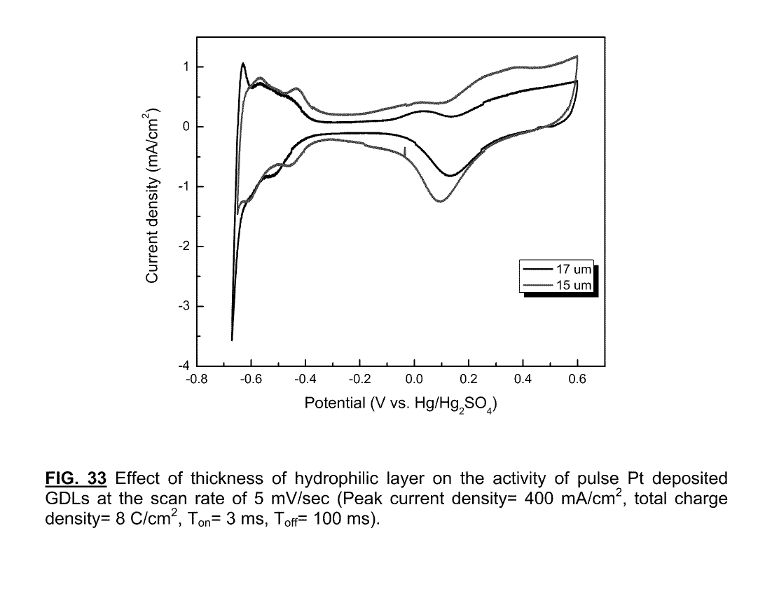

To optimize the ratio of hydrophilic and hydrophobic component in the layer, the thickness of the hydrophilic layer by tape casting method was varied and the results shown in FIG. 33. The pulse parameters were fixed at 400 mA/cm² peak current density, 3 ms on-time, 100 ms off-time. The total charge used to deposit the platinum was 8 C/cm². As thickness increases from 15 μm to 17 μm, the effective surface area also increases from 580 cm² to 630 cm². However, as thickness increases, blisters appear at the surface of the dried uncatalyzed carbon substrate.

Preparation of Pulse Deposited Gas Diffusion Electrode with Oxidized Carbon Substrate

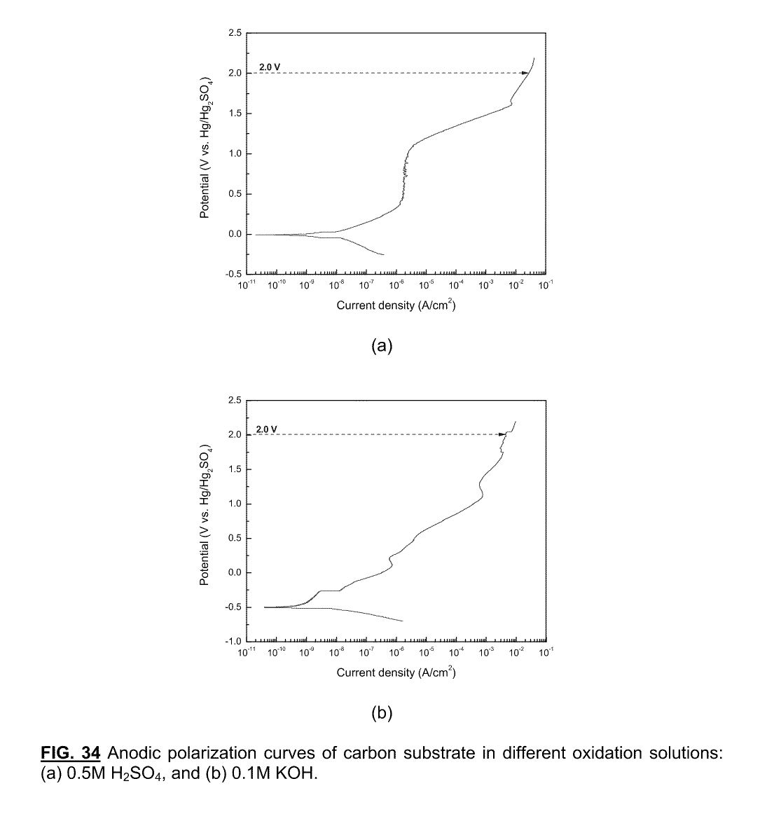

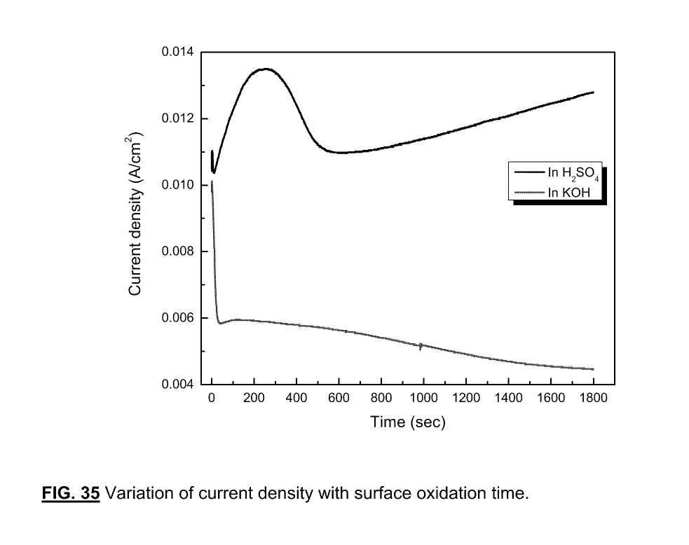

To evaluate the anodic polarization behavior of carbon electrode, anodic polarization tests were performed in 0.5 M H₂SO₄ and 0.1 M KOH solutions (FIG. 34). In 0.5 M H₂SO₄, the anodic polarization curve showed active-passive behavior, whereas active behavior was observed in 0.1 M KOH. This indicates that the commercial ELAT GDL was fabricated to be more resistive in acid media for fuel cell application. The applied potential for surface oxidation of 2 V was found to be sufficient to accelerate the formation of surface oxygen functional groups. FIG. 35 compares the current density changes as a function of time for carbon electrode at the applied potential of 2 V in 0.5 M H₂SO₄ and 0.1 M KOH solutions. Based on the current density variations, the following oxidation times were used for H₂SO₄ oxidation: 10 sec, 30 sec, 1 min, 5 min, and 10 min. The oxidation times when KOH was used as electrolyte were: 1 min, 5 min, 10 min and 30 min.

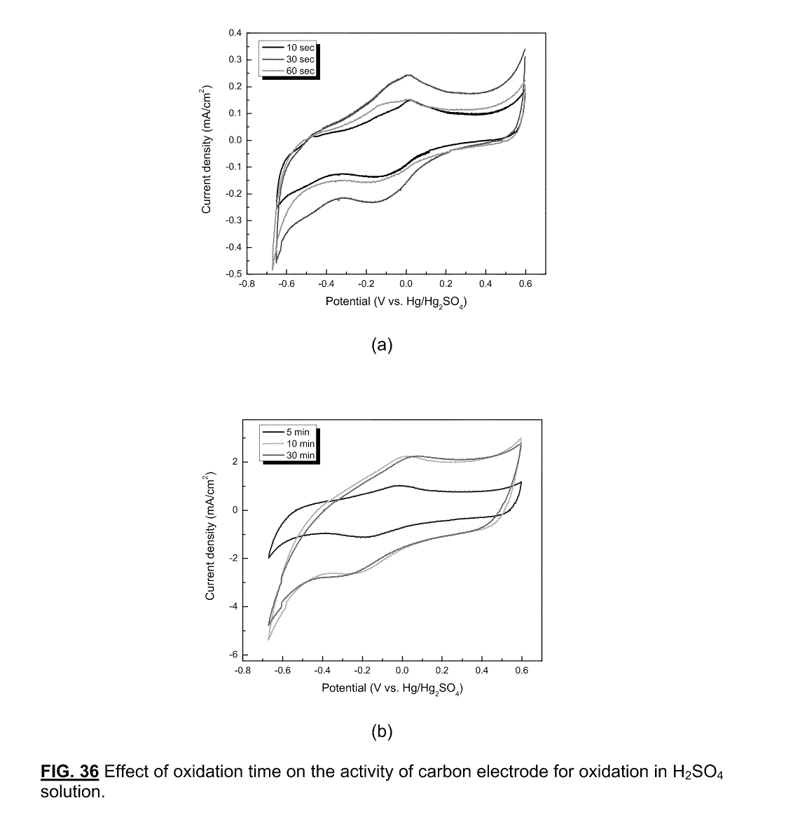

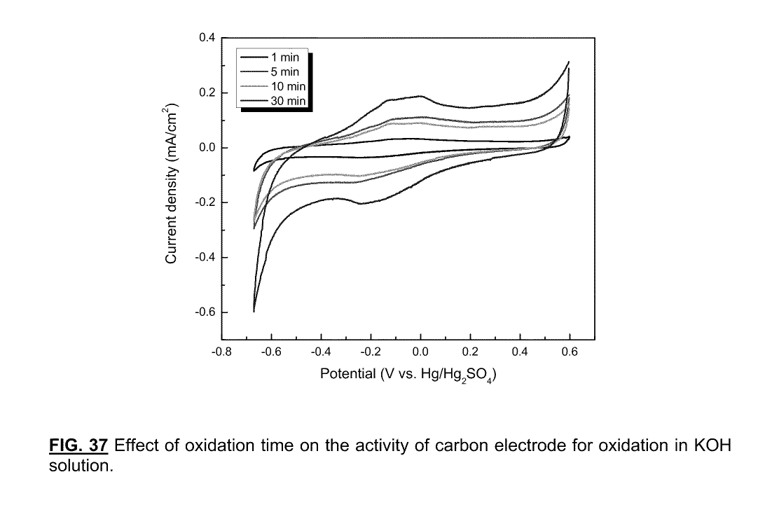

The CVs recorded after electrochemical oxidations in N₂ purged 0.5 M H₂SO₄ are shown in FIGS. 36 and 37. Note that the anodic peak current in the quinone-hydroquinone region (˜0 V) increased with oxidation time. The observed increase was also accompanied by a general increase in double layer charge in both solutions. This increased of double layer charge is attributed in part to the redox reaction of the surface functional group itself and is directly related to the hydrophilicity of the carbon surface. Thus, the surface oxidation of carbon electrode introduces hydrophilic nature to carbon electrode surface due to the formation of surface oxygen functional groups.

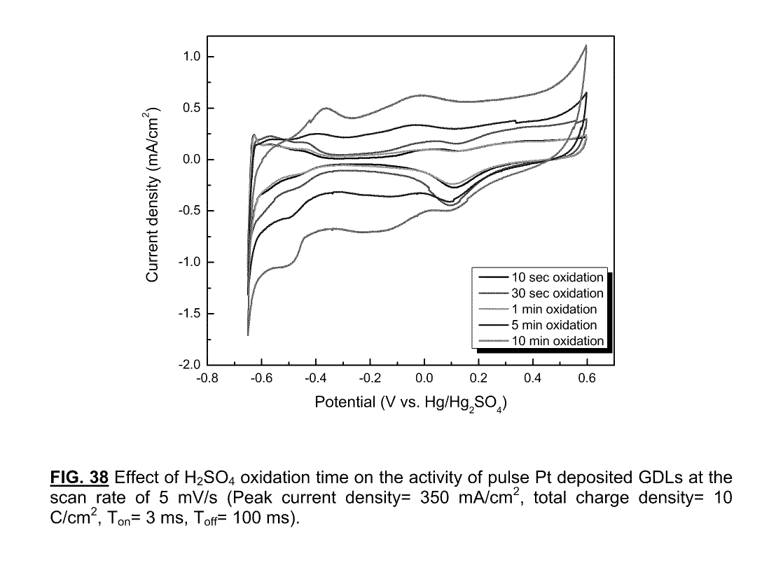

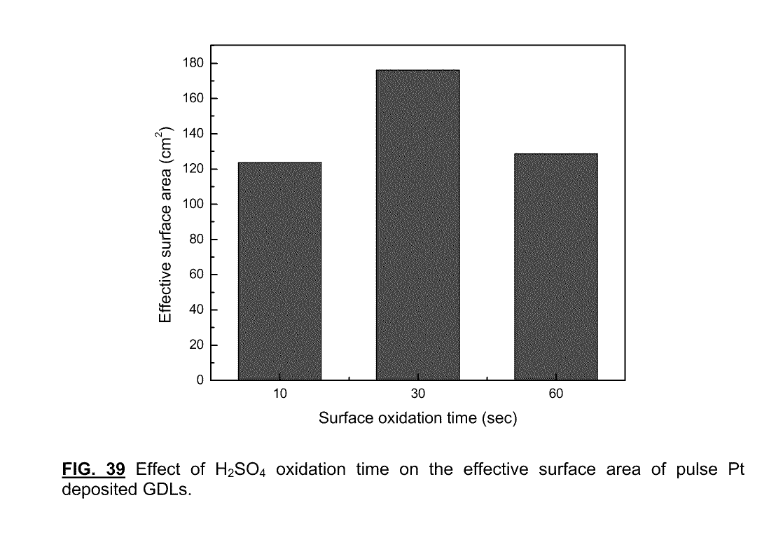

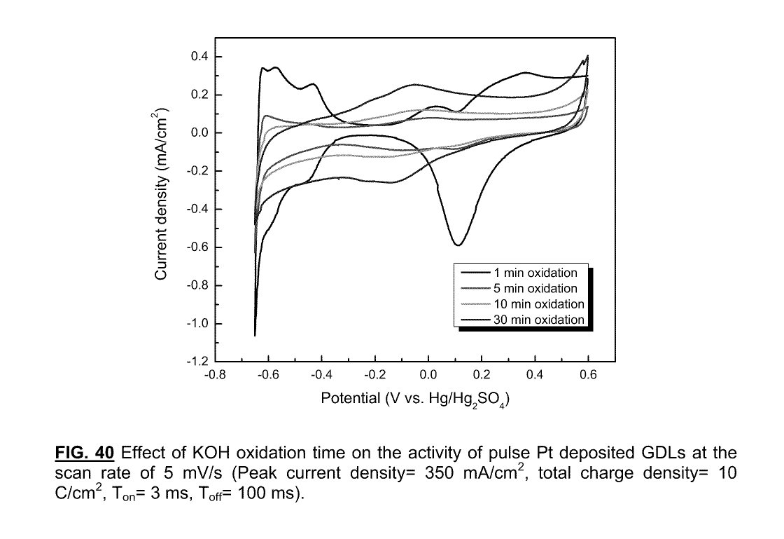

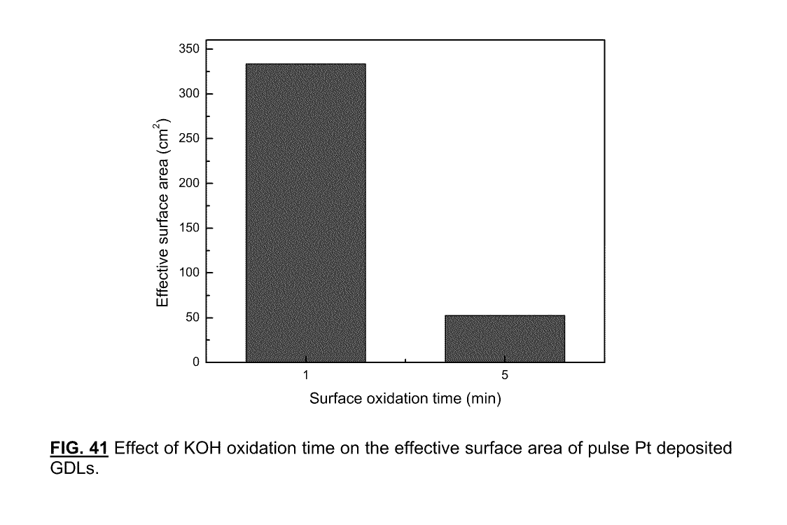

FIGS. 38 to 41 show the CVs of Pt deposited GDE and the effective surface area for oxidized samples as a function of oxidation time. The pulse parameters were fixed at 350 mA/cm² peak current density, 3 ms on-time, 100 ms off-time. The total charge density used was 10 C/cm². In the case of H₂SO₄ oxidation, the effective surface area of 30 sec oxidized sample showed higher value than those of 10 sec and 1 min oxidized samples. For KOH oxidation, 1 min oxidized sample showed more effective surface area than 5 min oxidized sample and revealed the highest surface area compared with H₂SO₄ oxidized samples.

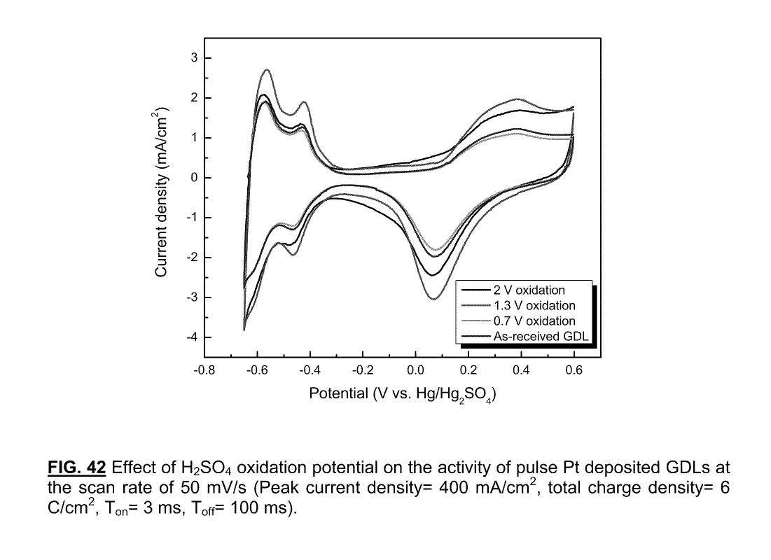

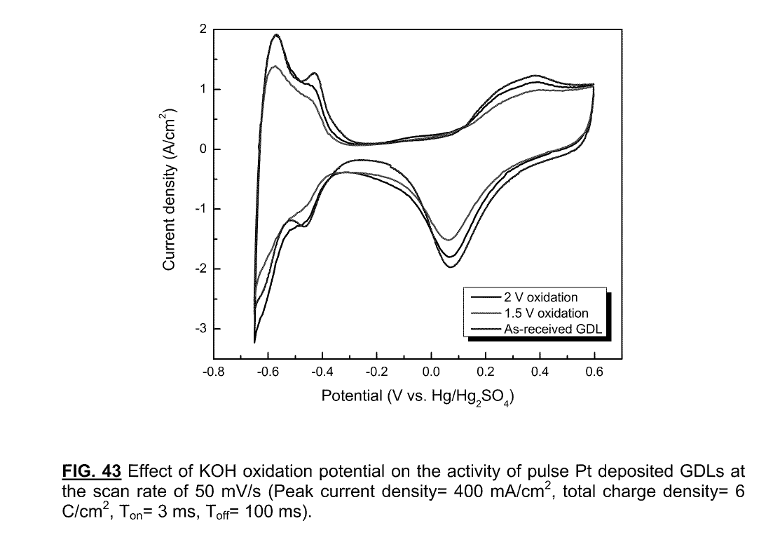

FIGS. 42 and 43 show the CVs of the Pt deposited GDE at different oxidized potential. The potentials of 0.7, 1.3 and 2.0 V were applied to activate the working electrode for H₂SO₄ activation process. When KOH solution was used to activate the surface, the applied potential were in the range of 1.5 to 2.0 V vs Hg/Hg₂SO₄ reference electrode. The pulse parameters were fixed at 400 mA/cm² peak current density, 3 ms on-time, 100 ms off-time. The total charge used to deposit the active material was 6 C/cm². The surface showed black color when the applied potential of 2.0 V was used in KOH oxidation, indicating that smaller particles of Pt have been deposited. However, the performance (effective surface area) of the oxidized samples shows lower value than those observed in our previous work.

Preparation of Gas Diffusion Electrode Using a Wetting Agent

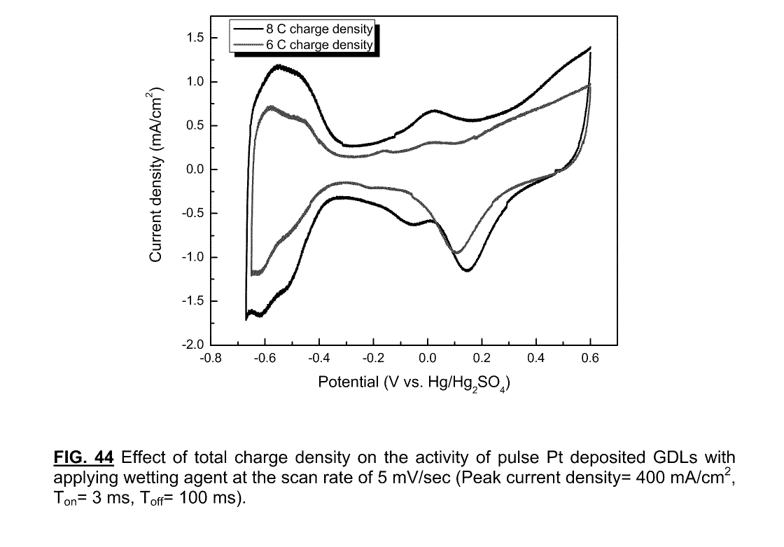

The as-received GDL surface is activated with the wetting agent followed by pulse deposition. The CV's obtained at the scan rate of 5 mV/sec are shown in FIG. 44. The pulse parameters were fixed as 400 mA/cm² peak current density, 3 ms on-time, and 100 ms off-time with varying total charge density. The effective surface area with the wetting agent is about 1,000 cm² for the charge density of 8 C/cm², and 600 cm² for the charge density of 6 C/cm² compared with 560 cm² obtained previously when charge density of 8 C/cm² were used to deposit the active material. The results indicated that activating the surface with wetting agent results in reproducible results. This method is breakthrough in the Pt deposition since it generates very low loading of Pt 0.01 mg/cm² with excellent distribution over the surface and very high electro active surface area. The thickness of the catalyst layer can be controlled by the wetting time in the range of less the micron to several microns

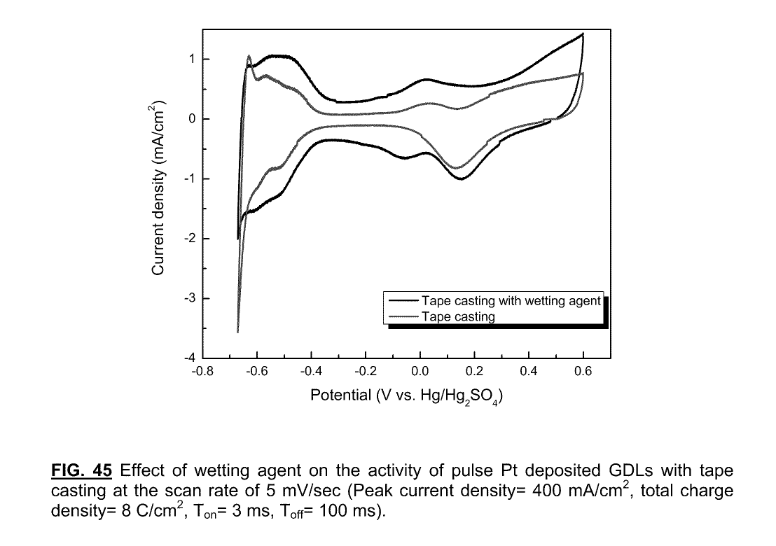

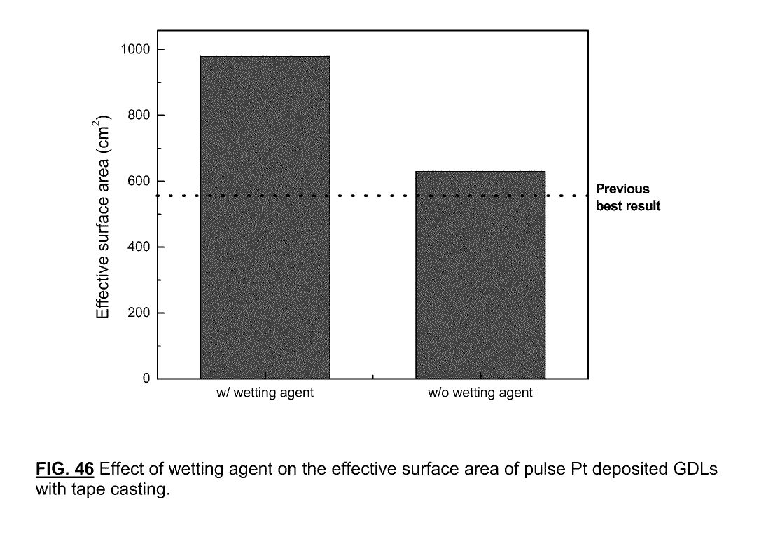

FIGS. 45 and 46 show the CVs compares the effective surface areas of the tape casting sample and the tape casting activated with wetting agent. The results indicated that the effective surface area increases from 630 cm² to 980 cm² when the GDL was activated using a wetting agent. Note that the effective surface area is almost the same between activated in wetting agent as-received GDL (1,000 cm²) and the tape casting GDL activated with the wetting (980 cm²).

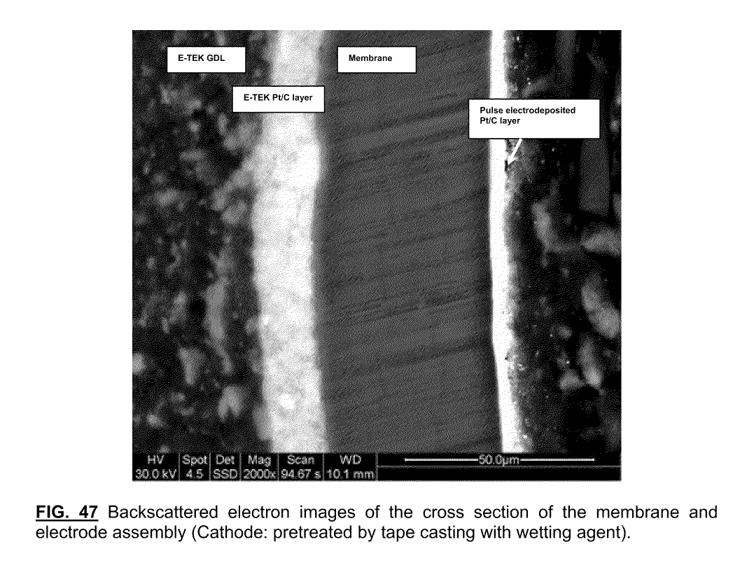

FIG. 47 shows backscattered electron images of the cross section of MEA consisting of an E-TEK anode and pulse deposited cathode. The cathode was pretreated by tape casting followed by applying wetting agent. The bright portions between the membrane and GDL are associated with the presence of Pt. The result shows that the thickness of the pulse deposited catalyst layer is very thin compared to that of the E-TEK anode. The thickness of pulse deposited layer is less than 5 μm, whereas commercially available sample has more than 10 μm thickness.

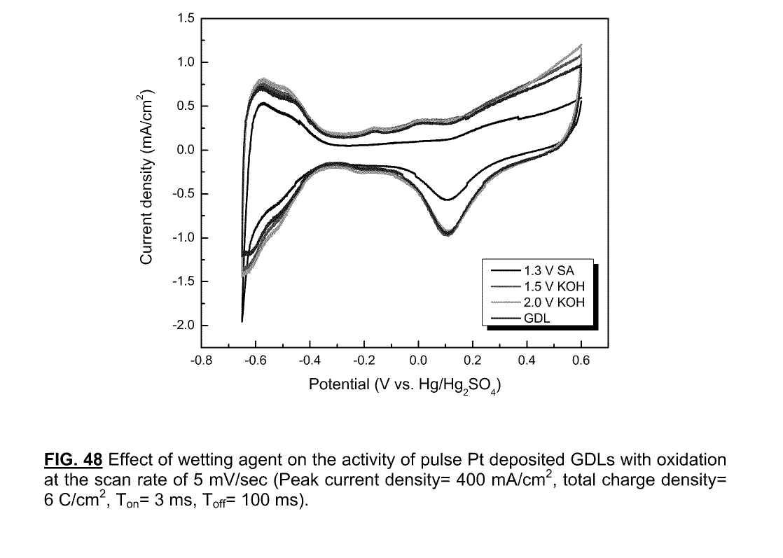

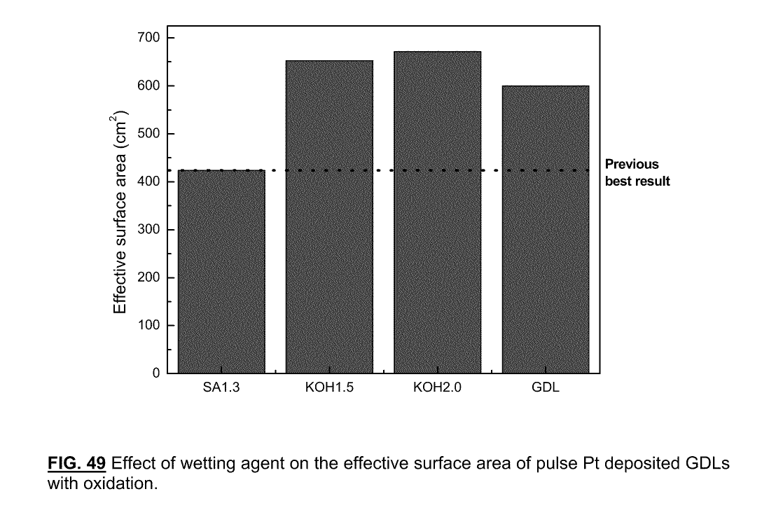

FIGS. 48 and 49 show the CVs and the effective surface areas of different Pt deposited samples prepared by varying the oxidation condition when the wetting agent was used to activate the GDL. The KOH oxidized specimens showed higher surface area than as-received GDL. Compared with our previous result, the effective surface area of Pt-deposited GDE has been increased by approximately 58%.

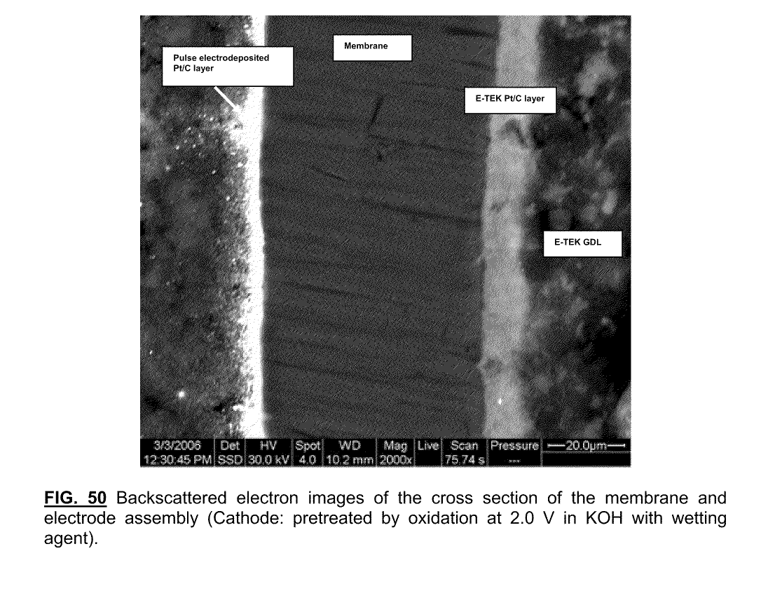

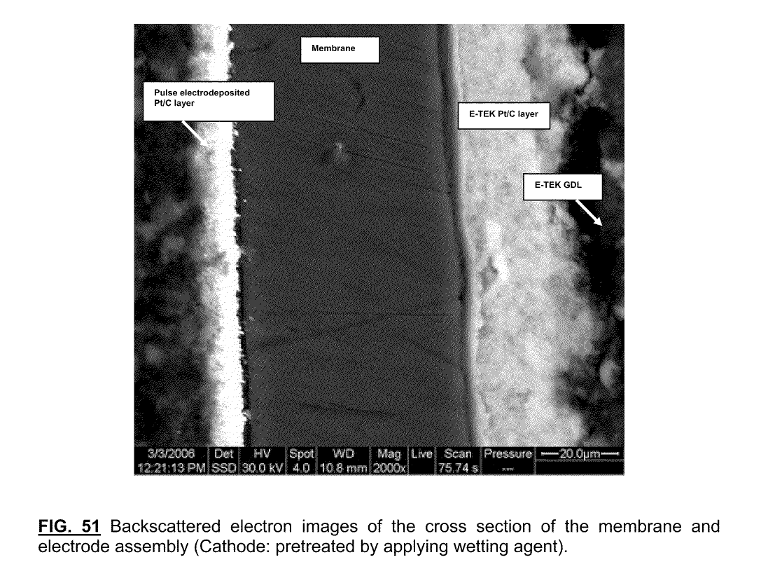

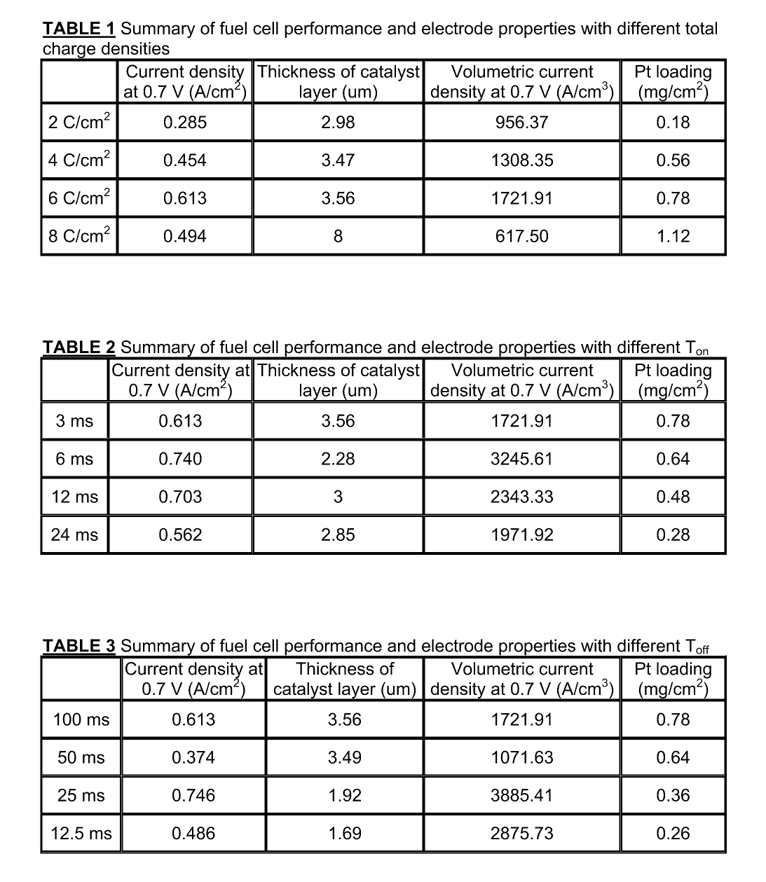

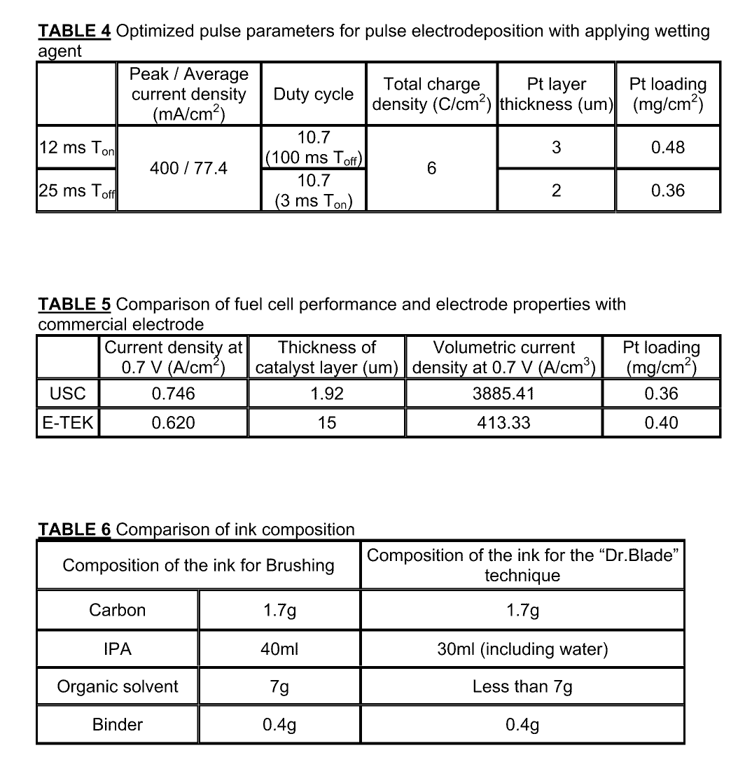

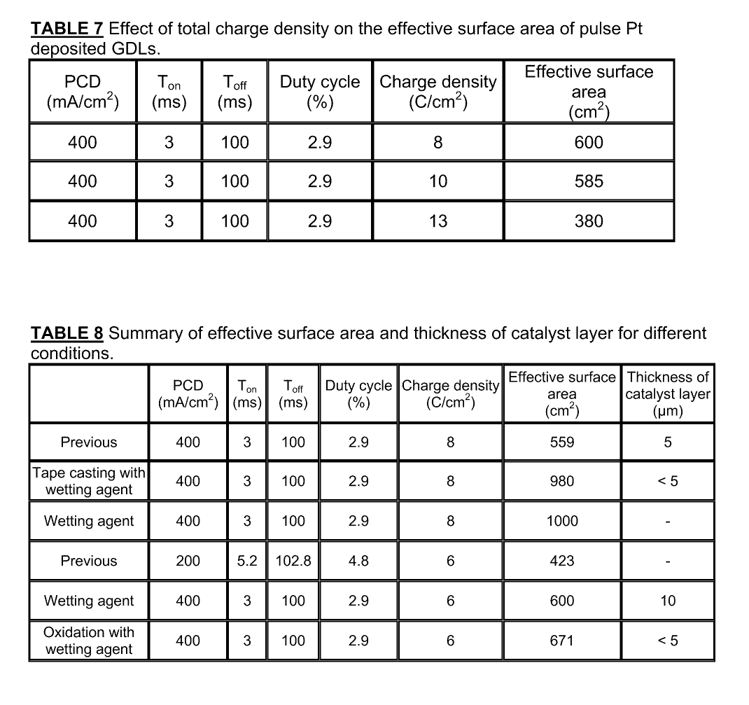

FIG. 50 displays the backscattered electron images of the cross section of MEA consisting of an E-TEK anode and pulse deposited cathode. The cathode was pretreated by oxidation in 2.0 V in KOH and activated in wetting agent solution. FIG. 51 shows the backscattered electron images of the cross section of MEA in case when the cathode was prepared by activating the as-received GDL with wetting agent. The pulse condition, the effective surface area and the thickness of the Pt catalyst layer obtained are compared to previous results in Table 8.

The pulse electrodeposition technique was developed as a new method for preparation cathodes for PEMFC's. In our approach, platinum is directly deposited on the surface of a carbon electrode. This method ensures most of platinum to be in close contact with the membrane.

To introduce the hydrophilic nature on the GDL, the following activation methods were tested: (i) hydrophilic layer was applied by tape casting, (ii) surface oxidation with sulfuric acid or potassium hydroxide, and (iii) surface activation by using a wetting agent.

In the case of Pt deposition on tape casting carbon electrode, an increase in total charge density from 8 C/cm² to 13 C/cm² decreased the catalytic activity of Pt catalyst. The peak current density did affect the active surface area of the Pt due to changes in Pt grain size. With increase in peak current density, the effective surface area of Pt also increased, indicating that smaller particles of Pt are deposited. The best performance was obtained for the peak current density of 400 mA/cm².

Electrochemical oxidation of carbon electrodes was performed in two different solutions; 0.5 M H₂SO₄ and in 0.1 M KOH at 25° C. It was found that KOH oxidized specimen showed higher effective surface area.

The effective surface area generated using wetting agent showed higher value when compared to that of the other activation methods used herein. The results indicated that activating the surface with wetting agent results in reproducible results. This method is breakthrough in the Pt deposition since it generates very low loading of Pt with excellent distribution over the surface and very high electro active surface area. The initial results indicated that thickness of the catalyst layer can be controlled by the wetting time in the range of less than micron to several microns.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the disclosure so further described in such appended claims.

What is claimed:

1. A method for forming a PEM fuel cell electrode comprising:
applying a hydrophilic wetting agent on an electrode surface;
depositing a catalyst layer on the wetted electrode surface by pulse electrodeposition, at least a portion of the catalyst penetrating the electrode surface; and
heat treating the electrode surface.

2. A method as in claim 1, wherein the electrode surface comprises carbon.

3. A method as in claim 1, wherein the wetting agent comprises isopropyl alcohol, ethanol, or octanol.

4. A method as in claim 1, wherein the wetting agent comprises isopropyl alcohol.

5. A method as in claim 1, wherein the catalyst comprises platinum.

6. A method as in claim 1, further comprising impregnating the electrode with an ionic polymer following heat treatment of the surface.

7. A method as in claim 6, further comprising bonding the electrode with a membrane to form a membrane electrode assembly.

8. A method as in claim 7, wherein the membrane electrode assembly has performance of at least 850 mA/cm² at a potential of about 0.7 V.

9. A method as in claim 7, wherein the membrane electrode assembly has performance of at least 900 mA/cm² at a potential of about 0.7 V.

10. A method as in claim 1, wherein the catalyst layer has a thickness of at least about 1 μm.

11. A method as in claim 1, wherein the catalyst layer has a thickness of at least about 2 μm.

12. A method for forming a PEM fuel cell electrode comprising:
applying a hydrophilic wetting agent on a carbon electrode surface;
depositing a platinum layer on the wetted electrode surface by pulse electrodeposition, at least a portion of the platinum penetrating the carbon electrode surface; and
heat treating the carbon electrode surface.

13. A method as in claim 12, wherein the wetting agent comprises isopropyl alcohol, ethanol, or octanol.

14. A method as in claim 12, wherein the wetting agent comprises isopropyl alcohol.

15. A method as in claim 12, further comprising impregnating the carbon electrode with an ionic polymer following heat treatment of the surface.

16. A method as in claim 15, further comprising bonding the carbon electrode with a membrane to form a membrane electrode assembly.

17. A method as in claim 16, wherein the membrane electrode assembly has performance of at least 850 mA/cm² at a potential of about 0.7 V.

18. A method as in claim 16, wherein the membrane electrode assembly has performance of at least 900 mA/cm² at a potential of about 0.7 V.

19. A method as in claim 12, wherein the platinum layer has a thickness of at least about 1 μm.

20. A method as in claim 12, wherein the platinum layer has a thickness of at least about 2 μm.
